(19) United States
(12) Patent Application Publication
(10) Pub. No.: US 2025/0030470 A1
(43) Pub. Date: Jan. 23, 2025

(54) METHOD AND APPARATUS FOR HANDLING SIDELINK REFERENCE SIGNAL FOR BEAM MANAGEMENT IN A WIRELESS COMMUNICATION SYSTEM

(71) Applicant: ASUS Technology Licensing Inc., Taipei City (TW)

(72) Inventors: Ming-Che Li, Taipei City (TW); Chun-Wei Huang, Taipei City (TW); Li-Chih Tseng, Taipei City (TW); Yi-Hsuan Kung, Taipei City (TW)

(21) Appl. No.: 18/775,874

(22) Filed: Jul. 17, 2024

Related U.S. Application Data
(60) Provisional application No. 63/528,302, filed on Jul. 21, 2023.
(60) Provisional application No. 63/528,311, filed on Jul. 21, 2023.

(51) Int. Cl. H04B 7/06; H04L 5/00; H04W 72/044; H04W 72/40

(52) U.S. Cl. CPC H04B 7/0626; H04L 5/0051; H04W 72/046; H04W 72/40

(57) ABSTRACT

Methods, systems, and apparatuses are provided for handling sidelink reference signals for beam management in a wireless communication system, with a method of a first device comprising being scheduled or requested to perform one or more standalone Sidelink (SL) Channel State Information Reference Signal (CSI-RS) transmissions, receptions, or measurements in a first sidelink Transmission Time Interval (TTI) in a first sidelink resource pool in a sidelink carrier or cell, being scheduled or requested to perform a first sidelink data and/or feedback transmission or reception in the first sidelink TTI in the sidelink carrier or cell, and determining to perform either the one or more standalone SL CSI-RS transmissions, receptions, or measurements, or the first sidelink data and/or feedback transmission or reception in the first sidelink TTI, at least based on a parameter of a standalone SL CSI-RS.

### CROSS-REFERENCE TO RELATED APPLICATIONS

The present Application claims priority to and the benefit of U.S. Provisional Patent Application Ser. No. 63/528,302, filed Jul. 21, 2023, and U.S. Provisional Patent Application Ser. No. 63/528,311,filed Jul. 21, 2023; with each of the referenced applications and disclosures fully incorporated herein by reference.

### FIELD

This disclosure generally relates to wireless communication networks and, more particularly, to a method and apparatus for handling sidelink reference signal for beam management in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling sidelink reference signals for beam management in a wireless communication system. For standalone Sidelink (SL) Channel State Information Reference Signal (CSI-RS) transmission, reception, and/or measurement, a User Equipment (UE) can acquire corresponding sidelink resources, and can handle and/or avoid different collision cases.

In various embodiments, a method of a first device comprises being scheduled or requested to perform one or more standalone SL CSI-RS transmissions, receptions, or measurements in a first sidelink Transmission Time Interval (TTI) in a first sidelink resource pool in a sidelink carrier or cell, being scheduled or requested to perform a first sidelink data and/or feedback transmission or reception in the first sidelink TTI in the sidelink carrier or cell, and determining to perform either the one or more standalone SL CSI-RS transmissions, receptions, or measurements, or the first sidelink data and/or feedback transmission or reception in the first sidelink TTI, at least based on a parameter of a standalone SL CSI-RS.

In various embodiments, a method of a first device comprises obtaining or receiving a configuration of a first sidelink resource pool in a sidelink carrier or cell, obtaining or receiving a configuration of a first one or more resources for standalone SL CSI-RS transmissions, receptions, or measurements in the sidelink carrier or cell, obtaining or receiving a configuration of a second one or more resources for SL data and/or feedback transmissions, receptions, or measurements in the sidelink carrier or cell, and performing one or more standalone SL CSI-RS transmissions, receptions, or measurements within the first one or more resources.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.35-1: Sidelink CSI Reporting MAC CE, from 3GPP TS 38.321 V17.5.0 (2023-06) 3GPP.

FIG. 6 is a reproduction of FIG. 3: A pair of SL UEs (A, B) performing SL beam refinement for unicast communication, from R1-2304344.

FIG. 7 is a reproduction of FIG. 4: SL beam refinement based on exhaustive beam search (slot-wise TX beam sweeping at UE A, symbol-wise RX beam sweeping at UE B), from R1-2304344.

FIG. 8 is a reproduction of FIG. 5: SL beam refinement based on Uu procedure [P-2, P-3] (UE A plays role of gNB) (symbol-wise TX beam sweeping at UE A, symbol-wise RX beam sweeping at UE B), from R1-2304344.

FIG. 9 is a reproduction of FIG. 6: SL beam refinement based on TX/RX beam correspondence [P-3, P-3] (symbol-wise RX beam sweeping at UE B, symbol-wise RX beam sweeping at UE A), from R1-2304344.

FIG. 10 is a reproduction of FIG. 4: Multiple CSI-RS in one slot, from R1-2305424.

FIG. 11 is a reproduction of FIG. 5: Stand-alone SL CSI-RS structure, from R1-2305424.

FIG. 12 is a reproduction of FIG. 6: Resource configuration between CSI-RS and PSFCH, from R1-2305424.

FIG. 13 is a reproduction of FIG. 3: Example of SL beam maintenance based on the existing SL CSI reporting, from R1-2305633.

FIG. 14 is a reproduction of FIG. 4: Example of SL beam maintenance based on the SL CSI reporting, from R1-2305633.

FIG. 15A is an example diagram showing one sidelink slot may comprise SL CSI-RS 1˜4 transmissions with corresponding SCI (PSCCH and 2nd stage SCI), in accordance with embodiments of the present invention.

FIG. 15B is an example diagram showing one sidelink slot may comprise SL CSI-RS 1˜9 transmissions with corresponding SCI (PSCCH and 2nd stage SCI), in accordance with embodiments of the present invention.

FIG. 16 is an example diagram showing that when sensing-based resource selection is triggered/requested in slot n, (the Physical layer of) the UE will have a (initial) set of candidate single-slot resources comprising multiple candidate single-slot resources, in accordance with embodiments of the present invention.

FIG. 17A is an example diagram showing that the first UE determines sidelink resource for standalone SL CSI-RS transmission based on the gray RX beam sensing result, in accordance with embodiments of the present invention.

FIG. 17B is an example diagram showing that the first UE may perform the 5 SL CSI-RS transmissions via different TX beams, in accordance with embodiments of the present invention.

FIG. 17C is an example diagram showing that the first UE may perform the 5 SL CSI-RS transmissions via different TX beams, in accordance with embodiments of the present invention.

FIG. 17D is an example diagram showing that the gray RX beam is determined as the reference beam for determining sidelink resource, in accordance with embodiments of the present invention.

FIG. 17E is an example diagram showing for TTI comprising more than one RX beam for monitoring (e.g., second TTI in the first sensing window), the UE would consider the sensing result in the second TTI is associated with gray RX beam (e.g., one RX beam for monitoring SCI) or the sensing result is associated with more than one RX beam(s), in accordance with embodiments of the present invention.

FIG. 18 is a flow diagram of a method of a first device comprising having/receiving a configuration of a network scheduling mode for acquiring sidelink resources(s), triggering or requesting to perform one or more standalone SL CSI-RS transmission(s) in a sidelink TTI, having no sidelink resources to perform the one or more standalone SL CSI-RS transmission(s), triggering a sidelink buffer status report to the network node, and transmitting the sidelink buffer status report to the network node, in accordance with embodiments of the present invention.

FIG. 19 is a flow diagram of a method of a first device comprising having/receiving a configuration of a network scheduling mode for acquiring sidelink resources(s), triggering or requesting to perform one or more standalone SL CSI-RS transmission(s) in a sidelink TTI, having no sidelink resources to perform the one or more standalone SL CSI-RS transmission(s), triggering a sidelink scheduling request to the network node, and transmitting the sidelink scheduling request to the network node, in accordance with embodiments of the present invention.

FIG. 20 is a flow diagram of a method of a first device comprising triggering or requesting to perform one or more standalone SL CSI-RS transmission(s), via one or more first TX beams, in one sidelink TTI, performing a first sensing-based resource selection for selecting one or more first sidelink resource(s) in a first sidelink resource pool, based on sensing result in the first sidelink resource pool, determining a first set of identified/valid candidate resources and selects the one or more first sidelink resource(s) from the first set of identified/valid candidate resources, and performing the one or more standalone SL CSI-RS transmission(s) on the selected one or more first sidelink resources, in accordance with embodiments of the present invention.

FIG. 21 is a flow diagram of a method of a first device comprising having/receiving a configuration of a set of time gaps for standalone SL CSI-RS transmission(s)/reception(s)/measurement(s) in a sidelink carrier/cell, and the first device (limits to) performs standalone SL CSI-RS transmission/reception/measurement within the set of time gap, in accordance with embodiments of the present invention.

FIG. 22 is a flow diagram of a method of a first device comprising being scheduled or requested to perform one or more standalone SL CSI-RS transmissions, receptions, or measurements in a first sidelink TTI in a first sidelink resource pool in a sidelink carrier or cell, being scheduled or requested to perform a first sidelink data and/or feedback transmission or reception in the first sidelink TTI in the sidelink carrier or cell, and determining to perform either the one or more standalone SL CSI-RS transmissions, receptions, or measurements, or the first sidelink data and/or feedback transmission or reception in the first sidelink TTI, at least based on a parameter of a standalone SL CSI-RS, in accordance with embodiments of the present invention.

FIG. 23 is a flow diagram of a method of a first device comprising obtaining or receiving a configuration of a first sidelink resource pool in a sidelink carrier or cell, obtaining or receiving a configuration of a first one or more resources for standalone SL CSI-RS transmissions, receptions, or measurements in the sidelink carrier or cell, obtaining or receiving a configuration of a second one or more resources for SL data and/or feedback transmissions, receptions, or measurements in the sidelink carrier or cell, and (limits to) performing one or more standalone SL CSI-RS transmissions, receptions, or measurements within the first one or more resources, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.213 V17.6.0 (2023-06) 3GPP; TSG RAN; NR; Physical layer procedures for control (Release 17); [2] 3GPP TS 38.214 V17.6.0 (2023-06) 3GPP; TSG RAN; NR; Physical layer procedures for data (Release 17); [3] 3GPP TS 38.212 V17.5.0 (2023-03) 3GPP; TSG RAN; NR; Multiplexing and channel coding (Release 17); [4] 3GPP TS 38.321 V17.5.0 (2023-06) 3GPP; TSG RAN; NR; Medium Access Control (MAC) protocol specification (Release 17); [5] RP-230077, “WID revision: NR sidelink evolution”, OPPO; [6] RAN1 Chair's Notes of 3GPP TSG RAN WG1 #112bis; [7] RAN1 Chair's Notes of 3GPP TSG RAN WG1 #113; [8] R1-2304344, “On Beam Management for Sidelink in FR2”, Nokia, Nokia Shanghai Bell; [9] R1-2304483, “Enhanced sidelink operation on FR2 licensed spectrum”, vivo; R1-2305424, “On sidelink beam management in FR2”, OPPO; and R1-2305633, “Discussion on enhanced sidelink operation on FR2 licensed spectrum”, LG Electronics. The standards and documents listed above are hereby expressly and fully incorporated herein by reference in their entirety.

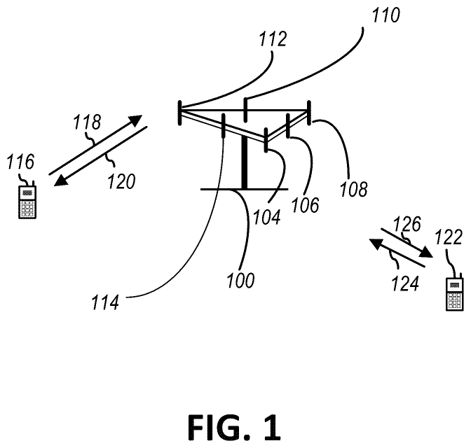

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

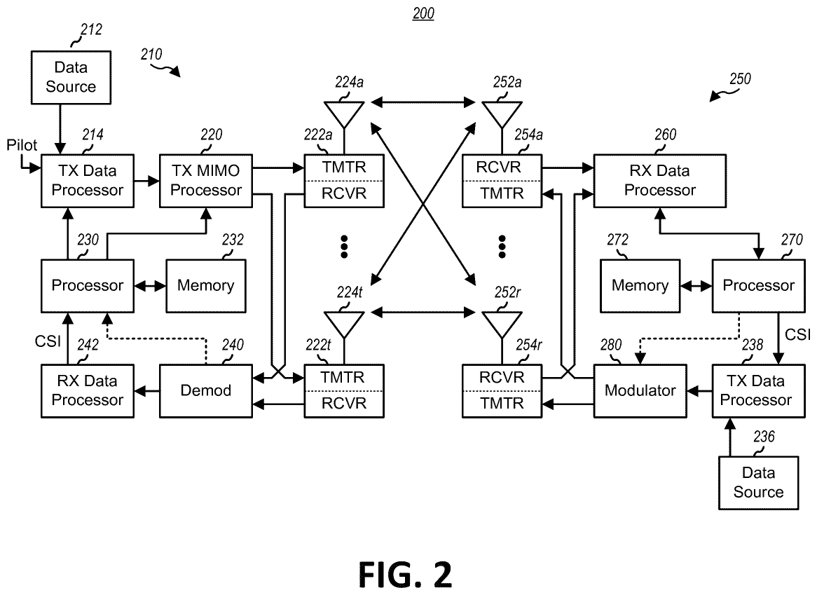

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

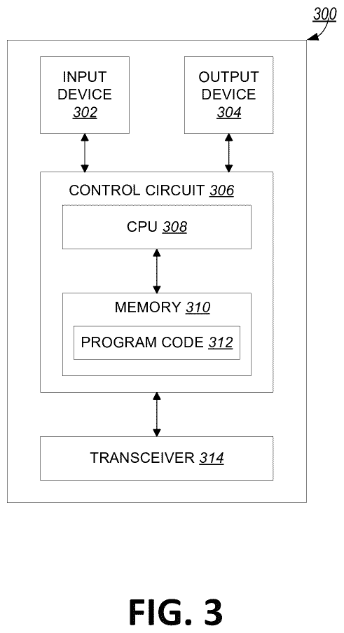

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

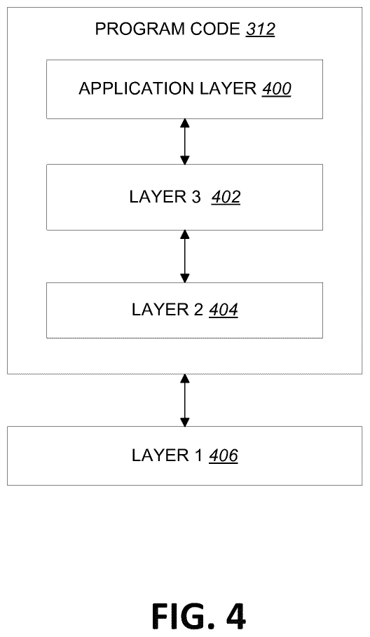

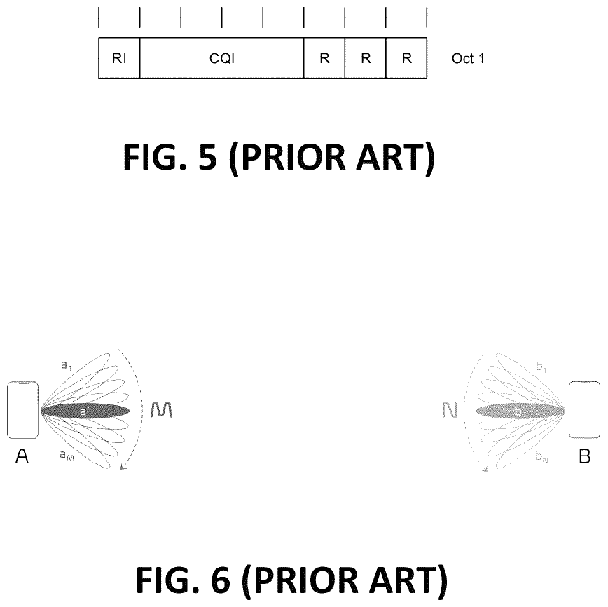

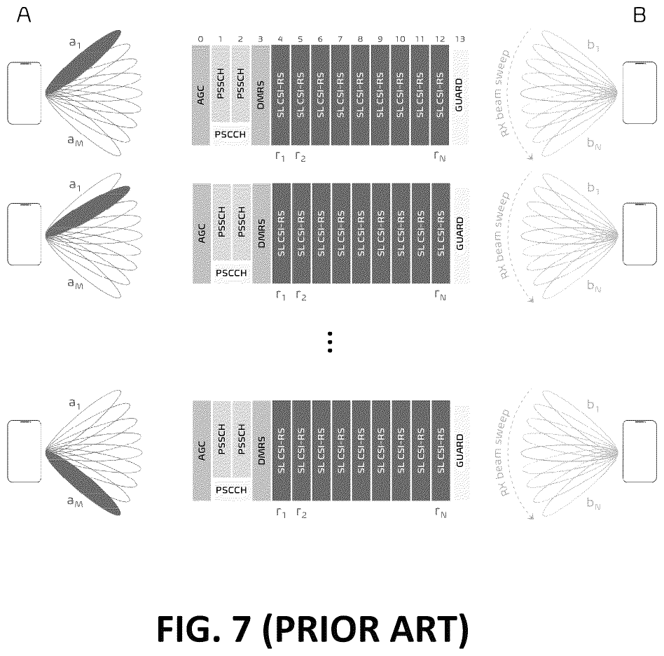

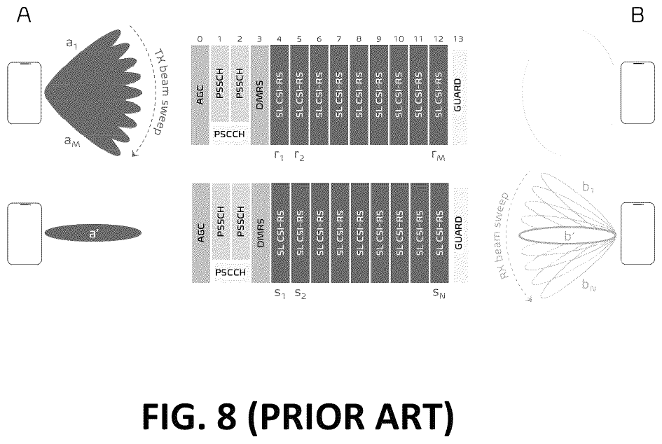

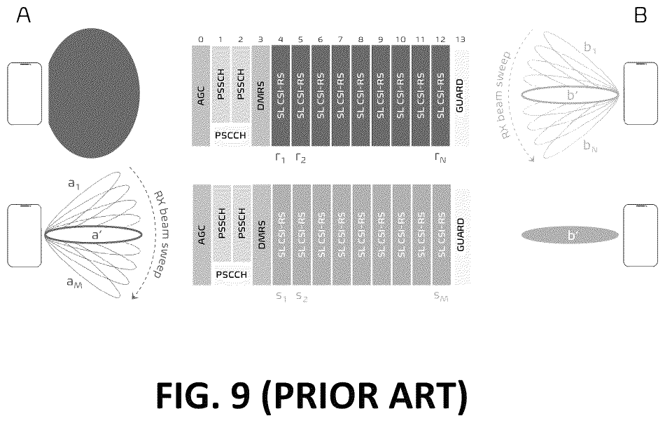

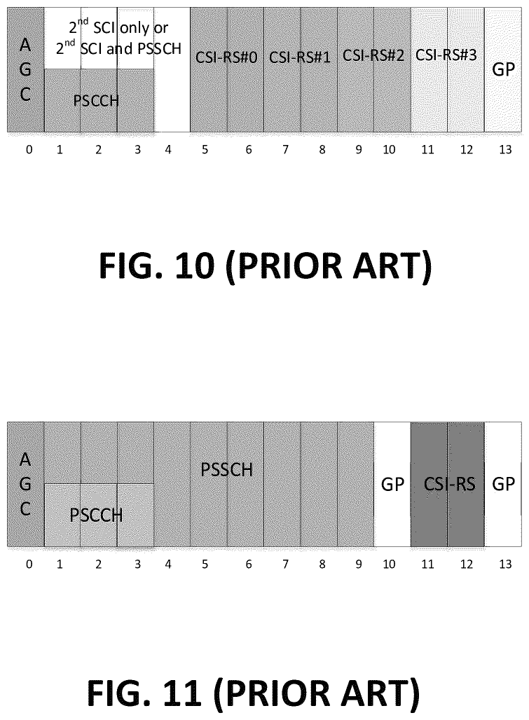

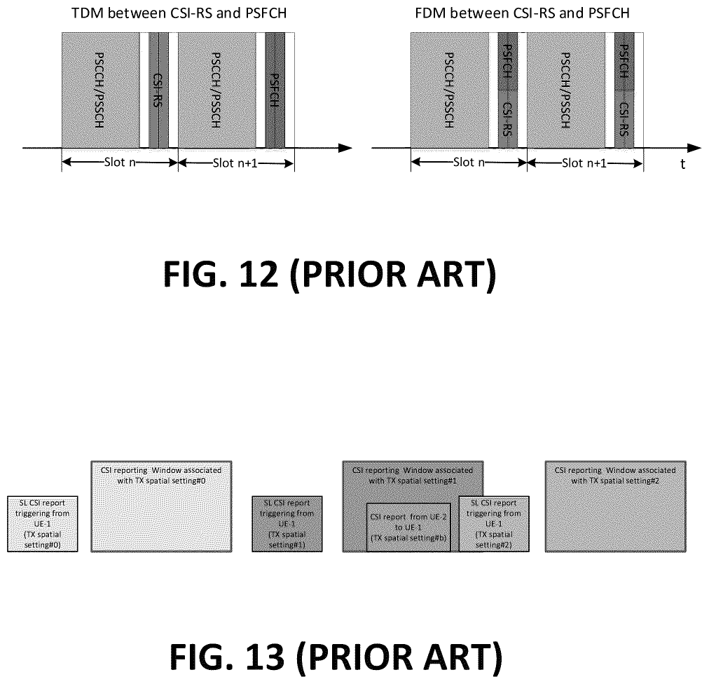

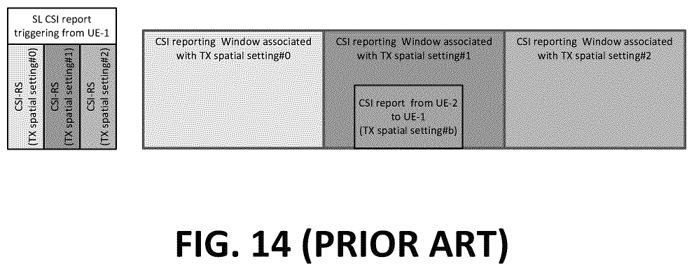

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In TS 38.213 ([1] 3GPP TS 38.213 V17.6.0 (2023-06) 3GPP), SL related procedure for control is specified.

For New Radio (NR) Release-16/17 (NR )sidelink design, sidelink slots can be utilized for Physical Sidelink Broadcast Channel (PSBCH) or Physical Sidelink Control Channel (PSCCH)/Physical Sidelink Shared Channel (PSSCH)/Physical Sidelink Feedback Channel (PSFCH) transmission/reception. PSBCH for Sidelink (SL) Synchronization Signal Block (SSB) is Time Division Multiplexed (TDMed), in slot level, from PSCCH/PSSCH/PSFCH. It means that sidelink slots except slots for PSBCH can be utilized for PSCCH/PSSCH/PSFCH transmission/reception. Moreover, the concept of a sidelink resource pool for sidelink communication is utilized for PSCCH/PSSCH and/or/PSFCH transmission and reception. A sidelink (communication) resource pool will comprise a set of sidelink slots (except at least slots for PSBCH) and a set of frequency resources. Different sidelink (communication) resource pools may be TDMed and/or Frequency Division Multiplexed (FDMed). More specifically, a PSCCH in one sidelink (communication) resource pool can only schedule PSSCH resource(s) in the same one sidelink (communication) resource pool. A PSCCH in one sidelink (communication) resource pool is not able to schedule PSSCH resource(s) in other/another sidelink (communication) resource pool. For a PSCCH/PSSCH, an associated PSFCH is in the same sidelink (communication) resource pool, instead of in different sidelink (communication) resource pools.

One sidelink (communication) resource pool will comprise multiple sub-channels in frequency domain, wherein a sub-channel comprises multiple contagious Physical Resource Blocks (PRBs) in frequency domain. One PRB comprises multiple Resource Elements (REs), e.g., one PRB consists of 12 REs. Configuration of the sidelink resource pool will indicate the number of PRBs of each sub-channel in the corresponding sidelink resource pool. Sub-channel based resource allocation in frequency domain is supported for PSSCH. For a PSSCH resource scheduled by a PSCCH in the same sidelink slot, fixed relationship between the PSCCH and the PSSCH resource is specified, which means that the PSCCH will be located in the lowest (index of) sub-channel of the scheduled PSSCH resource. As for scheduled PSSCH resource in different slot(s), starting frequency position of the scheduled PSSCH resource will be scheduled/indicated by sidelink control information, instead of a fixed relationship.

In current NR Release-16/17 sidelink design, one Sidelink Control Information (SCI) could indicate at most three PSSCH resources via Frequency resource assignment and/or Time resource assignment in the SCI. The SCI may comprise a 1st stage SCI and a 2nd stage SCI. The 1st stage SCI may be transmitted via PSCCH. The 2nd stage SCI may be transmitted via multiplexed with the scheduled PSSCH resource in the same sidelink slot, e.g., the first PSSCH resource. In other words, the SCI can schedule at most two PSSCH resources in later sidelink slots, e.g., the second PSSCH resource and/or the third PSSCH resource. The at most three PSSCH resources are in different slots in a sidelink (communication) resource pool. The at most three PSSCH resources are within 32 consecutive slots in a sidelink resource pool. The at most three PSSCH resources are utilized/associated with a same data packet, e.g., a same TB or a same Medium Access Control (MAC) Packet Data Unit (PDU). Note that standalone PSCCH/SCI is not supported in NR sidelink, which means that for each PSSCH transmission in a slot, there will be corresponding PSCCH/SCI transmission in the same slot, and vice versa.

Moreover, resource reservation for another/different Transport Block (TB) by a SCI could be (pre-)configured with enabled or not enabled or not configured in a sidelink (communication) resource pool. When a sidelink (communication) resource pool is configured with an enabled such resource reservation, the sidelink (communication) resource pool is configured with a set of reservation period values. Possible reservation periods could be 0, 1:99, 100, 200, 300, 400, 500, 600, 700, 800, 900, 1000 ms. A resource reservation period field in an SCI in the sidelink (communication) resource pool could indicate which reservation period value is for (future) resource reservation. The size/number of the set of reservation period values could be from 1 to 16.

In current NR Release-16/17 sidelink design, there are two sidelink resource allocation modes defined for NR sidelink communication:
mode 1 is that a base station/network node can schedule sidelink resource(s) to be used by a User Equipment (UE) for sidelink transmission(s);
mode 2 is that the UE determines (i.e., base station/network node does not schedule) sidelink transmission resource(s) within sidelink resources configured by base station/network node or pre-configured sidelink resources.

For network scheduling mode, e.g., NR sidelink resource allocation mode 1, the network node may transmit an SL grant, e.g., Downlink Control Information (DCI) format 3_0, on Uu interface for scheduling at most three PSSCH resources (for a same data packet). The sidelink grant comprises a “time gap” field and “Lowest index of the subchannel allocation to the initial transmission” fields for indicating the first PSSCH resource and/or the PSCCH resource in the specific slot, and also comprises a “Frequency resource assignment” field and a “Time resource assignment” field for indicating the second PSSCH resource and/or the third PSSCH resource (if any). The sidelink grant also comprises a “resource pool index” for indicating one sidelink (communication) resource pool, wherein the scheduled at most three PSSCH resources are within the indicated one sidelink (communication) resource pool. The Transmission (TX) UE may perform PSCCH and PSSCH transmissions on PC5 interface, in response to the received sidelink grant, for a data packet. The Uu interface means the wireless interface for communication between network and UE. The PC5 interface means the wireless interface for communication (directly) between UEs/devices.

For UE (autonomous) selection mode, e.g., NR sidelink resource allocation mode 2, since the transmission resource is not scheduled via a network node, the UE may require performing sensing before selecting a resource for transmission (e.g., sensing-based transmission), in order to avoid resource collision and interference from or to other UEs (especially UEs using NR sidelink). Full sensing is supported from NR Rel-16 sidelink, while partial sensing is supported from NR Rel-17 sidelink. Based on the result of the sensing procedure, the UE can determine a valid/identified resource set. The valid/identified resource set may be reported to higher layers (of the UE). The UE may (randomly) select one or multiple valid/identified resources from the valid/identified resource set to perform sidelink transmission(s) from the UE. The sidelink transmission(s) from the UE may be PSCCH and/or PSSCH transmission.

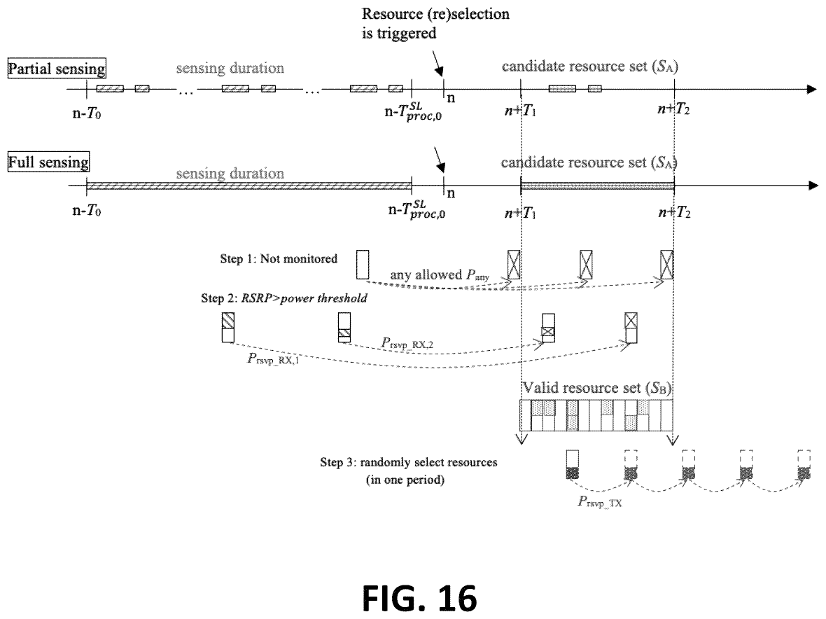

As shown in FIG. 16, when sensing-based resource selection is triggered/requested in slot n, (the Physical layer of) the UE will have a (initial) set of candidate single-slot resources comprising multiple candidate single-slot resources. The available (initial) set of candidate single-slot resources is restricted with time interval [n+T₁,n+T₂], which may be called the resource selection window. Preferably in certain embodiments, one candidate single-slot resource may comprise one or multiple frequency resource units within one slot, wherein the frequency resource unit may be a sub-channel. As specified in TS 38.214 ([2] 3GPP TS 38.214 V17.6.0 (2023-06) 3GPP), a candidate single-slot resource for transmission R_{x,y} is defined as a set of L_{subCH} contiguous sub-channels with sub-channel x+j in slot t′_{y}^{SL} where j=0, . . . , L_{subCH}−1. Note that Transmission Time Interval (TTI) may be a slot in NR.

If full sensing is performed (e.g., [2] 3GPP TS 38.214 V17.6.0 (2023-06) 3GPP), e.g., partially sensing is not configured, the (initial) set of candidate single-slot resources are in the (full) time interval [n+T₁,n+T₂]. The (Physical layer of the) UE shall monitor/sense slots within sensing window [n−T₀,n−T_{proc,0}^{SL}).

When partial sensing is performed/configured (e.g., [2] 3GPP TS 38.214 V17.6.0 (2023-06) 3GPP) (the Physical layer of) the UE determines by its implementation a set of candidate slots which consists of at least Y candidate slots within the time interval [n+T₁,n+T₂], wherein the (initial) set of candidate single-slot resources are in the set of slots. For periodic-based partial sensing, if a slot t′_{y}^{SL} is in the set of candidate slots, (the Physical layer of) the UE shall monitor/sense any slot

$${t}_{y - k \times {P}_{reserve}^{′}}^{′ SL}$$

within sensing window. For contiguous partial sensing, (the Physical layer of) the UE shall monitor/sense slots [n+T_{A},n+T_{B}] within sensing window, wherein TA and TB are both selected such that (the Physical layer of) the UE has sensing results starting at least M consecutive logical slots before the first slot of the selected Y candidate slots.

Based on the sensing result, (the Physical layer of) the UE may generate a valid/identified resource set, wherein the valid/identified resource set is a subset of the (initial) set of candidate single-slot resources. The generation of the valid/identified resource set may be performed via excluding some candidate single-slot resources from the (initial) set of candidate single-slot resources, for instance the step 1 and step 2 shown in FIG. 16. If remaining candidate single-slot resources after exclusion steps is smaller than X (e.g., either of 20%, 35%, 50% depending on prio_{TX}, which association is configured in sidelink resource pool configuration) of the number of the (initial) set of candidate single-slot resources, the UE may re-perform the exclusion step via increasing the power threshold by 3 dB. After then, (the Physical layer of) the UE can determine the valid/identified resource set. The resource selection for sidelink transmission, performed by higher layer (MAC layer) of the UE, may be randomly selected from the valid/identified resource set, e.g., step 3 shown in FIG. 16.

As specified in [2] 3GPP TS 38.214 V17.6.0 (2023-06) 3GPP, the first excluding step is that if (the Physical layer of) the UE does not monitor/sense a TTI z, (the Physical layer of) the UE cannot expect whether the candidate single-slot resources in TTI “z+P_{any}” are occupied or not, wherein P_{any} means any possible periodicity configured in the sidelink (communication) resource pool. For instance, the first excluding step is shown as step 1 in FIG. 16. The (Physical layer of) the UE excludes the candidate single-slot resources in TTI “z+q·P_{any}” and excludes the candidates single-slot resources for which other UE(s) may have possible transmission occurring in TTI “ [symbol] +q·P_{any}”, wherein q is 1 or 1, 2, . . . ,

$$⌈ \frac{{T}_{scal}}{{P}_{rsvp \_ RX}} ⌉ .$$

The parameter q means that the UE excludes multiple candidate single-slot resources with period P_{rsvp_RX} within time interval [z, z+T_{scal}].

The second excluding step is that if (the Physical layer of) the UE receives/detects a sidelink control signaling (e.g., SCI format 1) in a TTI m, (the Physical layer of) the UE may exclude the candidate single-slot resources according to the received sidelink control signaling. For instance, the second excluding step is shown as step 2 in FIG. 16. More specifically, if (the Physical layer of) the UE receives/detects a sidelink control signaling scheduling a transmission in a TTI m and the measurement result for the sidelink control signaling is higher than a power threshold, (the Physical layer of) the UE may exclude the candidate single-slot resources according to the received sidelink control signaling. The measurement result may be Reference Signal Received Power (RSRP). More specifically, the measurement result may be PSCCH-RSRP or PSSCH-RSRP. The sidelink control signaling may schedule/indicate the resources of the scheduled transmission and/or periodicity of the scheduled transmission, P_{rsvp_RX}. The excluded candidate single-slot resources according to the received sidelink control signaling are the resources of the next one or multiple scheduled transmission(s) based on the resources of the scheduled transmission and/or periodicity of the scheduled transmission. The next multiple scheduled transmissions may be with period P_{rsvp_RX} within time interval [z, z+T_{scal}]. The power threshold is determined based on priorx (priority value indicated by the received sidelink control information/signaling) and priorx (priority value provided by the UE's higher layer for the UE's data/PSSCH transmission). The association between the power threshold and (prio_{RX}, prio_{TX}) is configured by higher layer (e.g., configuration of the sidelink (communication) resource pool).

In current NR Release-16/17 sidelink, it operates in FR1 band/spectrum (e.g., 450-6000 MHz), wherein no beam management is applied. Besides, SL Channel State Information Reference Signal (CSI-RS) can be supported for sidelink channel measurement for sidelink unicast. The TX UE can transmit one SL CSI-RS multiplexed with one PSSCH, wherein the TX UE will also transmit SCI for scheduling the PSSCH and set “CSI request” field in SCI format 2-A or 2-C (which is 2-nd stage SCI) to 1. When the RX UE receives the SCI (including the SCI 2-A or 2-C) and PSSCH and also measures the SL CSI-RS, the RX UE may generate a corresponding SL CSI report (via an SL CSI reporting MAC Control Element (CE)) for transmitting to the TX UE.

Moreover, an SCI scheduling PSSCH transmission(s) will indicate a priority value associated with the scheduled PSSCH transmission(s). The sidelink control information scheduling PSSCH transmission(s) will also indicate cast type associated with the scheduled PSSCH transmission(s), e.g., unicast, groupcast, or broadcast. The sidelink control information (more specifically, the 2nd stage SCI) also indicates a (layer-1) source Identify (ID) and a (layer-1) destination ID. Preferably in certain embodiments, the (layer-1) destination ID is utilized for RX UE(s) to know whether to receive and/or decode the scheduled PSSCH transmission. Preferably in certain embodiments, the (layer-1) source ID is utilized for the RX UE to know whether two scheduled PSSCH transmissions are from the same TX UE or not, and/or know whether two scheduled PSSCH transmissions can be Hybrid Automatic Repeat Request (HARQ)-combined or not.

As specific in Work Item Description (WID) on NR sidelink evolution [6] RAN1 Chair's Notes of 3GPP TSG RAN WG1 #112bis, sidelink operation in FR2 (e.g., 24250-52600 MHz) is beneficial for increasing data rate with larger bandwidth. Currently, there are some studies on enhanced sidelink operation on FR2 licensed bands/spectrums (FR2 unlicensed spectrum may be also possible in future). However, FR2 bands/spectrums will experience significant atmospheric attenuation and path loss during propagation, thus beam-based management is necessary for sidelink operation in FR2. Accordingly, sidelink (initial) beam pairing, sidelink beam maintenance, and sidelink beam failure recovery need further study.

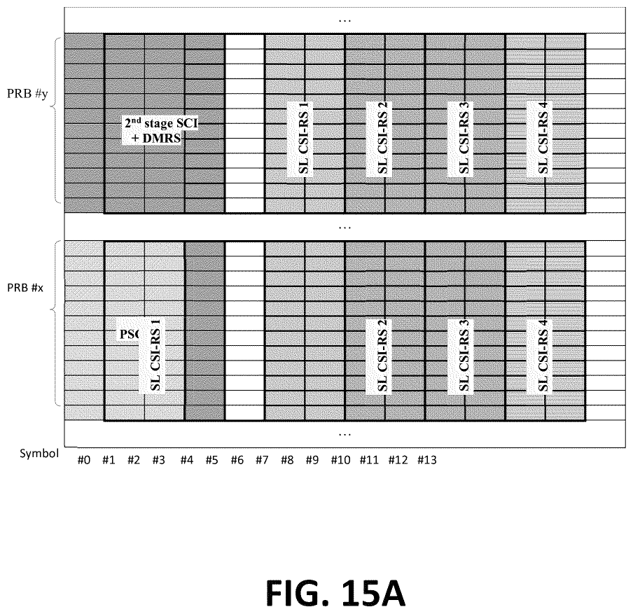

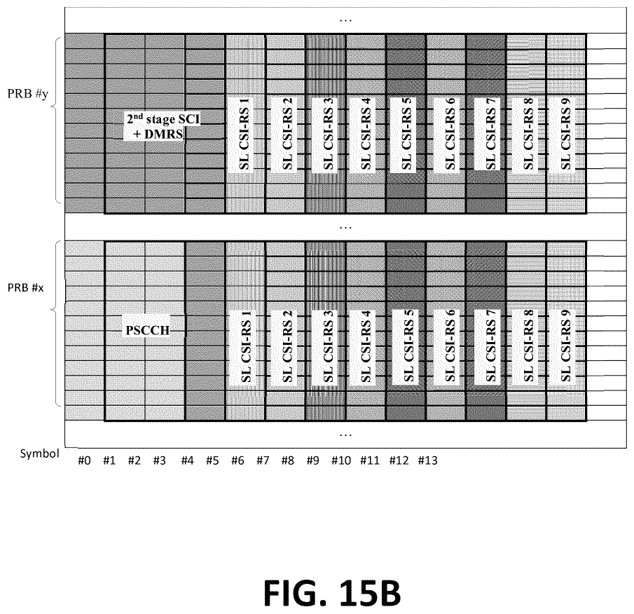

RAN1 agreements and some contributions (e.g., [8] R1-2304344, [9] R1-2304483, R1-2305424, and [11] R1-2305633) consider using SL CSI-RS as a starting point for beam maintenance and/or beam pairing. In NR Release-16/17 sidelink, SL CSI-RS is mainly for sidelink channel measurement, and SL CSI-RS is always multiplexed with PSSCH, which is called non-standalone SL CSI-RS. However, when SL CSI-RS is utilized for beam management in FR2, a TX UE may need to perform multiple SL CSI-RS transmissions on multiple TX beams. In this case, non-standalone SL CSI-RS seems not efficient since the TX UE may not always have available sidelink data to generate multiple PSSCH transmissions for multiplexing the multiple SL CSI-RS transmissions. Besides, multiple non-standalone SL CSI-RS transmissions are performed in multiple sidelink slots, which induce larger latency on beam management. To deal with such drawbacks, it is agreed to consider standalone SL CSI-RS transmissions, which means at least no accompanying PSSCH transmission in the same sidelink slot. Furthermore, it is possible to multiplex/comprise multiple standalone SL CSI-RS transmissions (via TDMed) in one sidelink slot. For instance, as shown in FIG. 15A, one sidelink slot may comprise SL CSI-RS 1˜4 transmissions with corresponding SCI (PSCCH and 2nd stage SCI). For instance, as shown in FIG. 15B, one sidelink slot may comprise SL CSI-RS 1˜9 transmissions with corresponding SCI (PSCCH and 2nd stage SCI). In one embodiment, the TX UE may transmit the multiple SL CSI-RS transmissions with the same TX beam, and the RX UE may receive/measure the multiple SL CSI-RS transmissions with different RX beams. In one embodiment, the TX UE may transmit the multiple SL CSI-RS transmissions with a different TX beam, and the RX UE may receive/measure the multiple SL CSI-RS transmissions with the same RX beams. Note that the TX UE may perform one SL CSI-RS transmission via one TX beam. The TX UE may perform one SL CSI-RS transmission not via more than one TX beam. The SL CSI-RS for beam management may be aperiodic, periodic, and/or semi-persistent SL CSI-RS.

In NR Release-16/17 sidelink, there are some priority-based operations for PSSCH and/or PSFCH transmission and reception. For instance, when PSSCH/PSFCH transmission collides with PSSCH/PSFCH reception (e.g., in time domain in a sidelink carrier/cell/Bandwidth Part (BWP)), the UE will determine to perform either PSSCH/PSFCH transmission or PSSCH/PSFCH reception based on associated priorities. For instance, when PSSCH transmission collides with other PSSCH transmission(s) (e.g., in time and/or frequency domain in a sidelink carrier/cell/BWP), the UE will determine to perform which one PSSCH transmission based on associated priorities. For instance, when a PSFCH transmission collides with another/other PSFCH transmission) (e.g., in time domain in a sidelink carrier/cell/BWP), the UE will determine to perform which N PSFCH transmissions based on associated priorities. In sidelink resource allocation mode 2, priority associated with PSSCH is utilized for resource sensing, reservation, re-evaluation, and/or a pre-emption operation/procedure. The SCI (e.g., SCI format 1-A or 1st stage SCI on PSCCH) scheduling PSSCH will indicate a priority value associated with the scheduled PSSCH. Note that for sidelink, the priority value is any of 1 to 8, and a lower priority value means higher priority. For SL CSI-RS in NR Release-16/17 sidelink, since SL CSI-RS is always multiplexed with PSSCH and SL CSI-RS is not associated with specific services or a specific higher layer protocol, there is no need to assign/allocate a specific priority value to SL CSI-RS. Regarding Sidelink Positioning Reference Signal (SL PRS) introduced in SL positioning/ranging, since SL PRS is performed for positioning/ranging services, higher layer, e.g., Sidelink LTE Positioning Protocol (SLPP) or application layer, may provide a priority value (to Physical layer or MAC layer) for a corresponding SL PRS transmission/reception.

Considering standalone SL CSI-RS for FR2 beam management, it may have some collision issues, such as:
TX/TX collision: standalone SL CSI-RS transmission and PSCCH/PSSCH/PSFCH transmission, especially TX UE may not simultaneously generate two TX beams for SL CSI-RS transmission and PSCCH/PSSCH/PSFCH transmission, respectively;
RX/RX collision: standalone SL CSI-RS reception/measurement and PSCCH/PSSCH/PSFCH reception, especially RX UE may not simultaneously receive via two RX beams for SL CSI-RS reception/measurement and PSSCH/PSFCH reception, respectively; or
TX/RX collision: for half-duplex UE, standalone SL CSI-RS transmission and PSCCH/PSSCH/PSFCH reception, or standalone SL CSI-RS reception/measurement and PSCCH/PSSCH/PSFCH transmission.

On the other hand, the TX UE may need to acquire sidelink resource(s) for standalone SL CSI-RS transmission. However, such standalone SL CSI-RS transmission does not comprise sidelink data (e.g., MAC Service Data Unit (SDU) or sidelink data from SL logical channels). How to acquire sidelink resources for standalone SL CSI-RS transmission(s) needs further study and design, for both sidelink resource allocation mode 1 and mode 2.

To deal with the issues, some concepts/mechanisms/methods/embodiments are provided in the following:

A first UE may have configuration of a set of sidelink resource pools within one sidelink BWP or one sidelink carrier/cell. The one sidelink BWP or the one sidelink carrier/cell may be in FR2 band/spectrum. The set of sidelink resource pools may be FDMed and/or TDMed. The first UE may perform standalone SL CSI-RS transmission/reception/measurement in a first one or more sidelink resource pools of the set of sidelink resource pools. Preferably in certain embodiments, the first one or more sidelink resource pools may comprise a first sidelink resource pool. The first (one or more) sidelink resource pool may be enabled or configured for standalone SL CSI-RS transmission/reception/measurement. The first UE may perform sidelink communication (e.g., PSCCH/PSSCH and/or PSFCH transmission/reception) in a second one or more sidelink resource pools of the set of sidelink resource pools. Preferably in certain embodiments, the second one or more sidelink resource pools may comprise a second sidelink resource pool.

Preferably in certain embodiments, the second one or more sidelink resource pools may comprise the first one or more sidelink resource pools. Preferably in certain embodiments, the second one or more sidelink resource pools are the same as the first one or more sidelink resource pools. Preferably in certain embodiments, the first UE may perform standalone SL CSI-RS transmission/reception/measurement and sidelink communication in the first sidelink resource pool.

Alternatively, the second one or more sidelink resource pools are different/exclusive from the first one or more sidelink resource pools. Preferably in certain embodiments, the first UE may perform standalone SL CSI-RS transmission/reception/measurement in the first sidelink resource pool and perform sidelink communication in the second sidelink resource pool. Preferably in certain embodiments, the first (one or more) sidelink resource pool may be TDMed from the second (one or more) sidelink resource pool. Preferably and/or alternatively, the first sidelink resource pool may (partially) overlap in time domain with the second sidelink resource pool.

### Concept A

Concept A is to introduce a parameter/characteristic of standalone SL CSI-RS. The SL CSI-RS is not associated with specific services or a specific higher layer protocol (higher than Physical Layer (PHY)/MAC/Radio Resource Control (RRC) layer, e.g., application layer). For time-domain collision case between standalone SL CSI-RS and PSSCH/PSFCH (in the one sidelink BWP or the one sidelink carrier/cell), the first UE may determine to perform one of them at least based on the parameter/characteristic of standalone SL CSI-RS.

Preferably in certain embodiments, when the first UE would transmit one or more standalone SL CSI-RS transmission(s) in a sidelink TTI and would transmit a PSSCH/PSFCH transmission in the sidelink TTI, the first UE determines to perform either the one or more standalone SL CSI-RS transmission(s) or the PSSCH/PSFCH transmission in the sidelink TTI, at least based on the parameter/characteristic of the one or more standalone SL CSI-RS transmission(s). The first UE may not perform the other transmission(s) in the sidelink TTI.

Preferably in certain embodiments, when the first UE would receive/measure one or more standalone SL CSI-RS transmission(s) in a sidelink TTI and would receive a PSSCH/PSFCH transmission in the sidelink TTI, the first UE determines to perform either the one or more standalone SL CSI-RS reception(s)/measurement(s) or the PSSCH/PSFCH reception in the sidelink TTI, at least based on the parameter/characteristic of the one or more standalone SL CSI-RS transmission(s). The first UE may not perform the other reception(s) in the sidelink TTI.

Preferably in certain embodiments, when the first UE would receive/measure one or more standalone SL CSI-RS transmission(s) in a sidelink TTI and would transmit a PSSCH/PSFCH transmission in the sidelink TTI, the first UE determines to perform either the one or more standalone SL CSI-RS reception(s)/measurement(s) or the PSSCH/PSFCH transmission in the sidelink TTI, at least based on the parameter/characteristic of the one or more standalone SL CSI-RS transmission(s). The first UE may not perform the other in the sidelink TTI.

Preferably in certain embodiments, when the first UE would transmit one or more standalone SL CSI-RS transmission(s) in a sidelink TTI and would receive a PSSCH/PSFCH transmission in the sidelink TTI, the first UE determines to perform either the one or more standalone SL CSI-RS transmission(s) or the PSSCH/PSFCH reception in the sidelink TTI, at least based on the parameter/characteristic of the one or more standalone SL CSI-RS transmission(s). The first UE may not perform the other in the sidelink TTI.

In method A1, the parameter/characteristic of standalone SL CSI-RS may be a first priority value provided by configuration of the first sidelink resource pool, wherein the one or more standalone SL CSI-RS transmission(s)/reception(s)/measurement(s) is performed in the first sidelink resource pool. The first UE may determine a second priority value of the PSSCH/PSFCH transmission/reception. For the PSSCH transmission/reception comprising sidelink data from one or more SL logical channel(s) and/or SL MAC CE(s), the second priority value may be determined based on the one or more logical channel(s) and/or the SL MAC CE(s). For the PSFCH transmission/reception, the second priority value may be determined based on associated PSSCH reception/transmission. Preferably in certain embodiments, the first UE may perform the one with a smaller priority value among the first priority value and the second priority value. Preferably in certain embodiments, when the first priority value is smaller than the second priority value, the first UE may perform the one or more standalone SL CSI-RS transmission(s)/reception(s)/measurement(s) (not perform the PSSCH/PSFCH transmission/reception) in the sidelink TTI. Preferably in certain embodiments, when the second priority value is smaller than the first priority value, the first UE may perform the PSSCH/PSFCH transmission/reception (not perform the one or more standalone SL CSI-RS transmission(s)/reception(s)/measurement(s)) in the sidelink TTI.

In method A2, the parameter/characteristic of standalone SL CSI-RS may be a first priority value provided by configuration associated with a second UE/destination, wherein the one or more standalone SL CSI-RS transmission(s) is performed for the second UE/destination or the one or more standalone SL CSI-RSs is transmitted from the second UE/destination. The first UE may determine a second priority value of the PSSCH/PSFCH transmission/reception. For the PSSCH transmission/reception comprising sidelink data from one or more SL logical channel(s) and/or SL MAC CE(s), the second priority value may be determined based on the one or more logical channel(s) and/or the SL MAC CE(s). For the PSFCH transmission/reception, the second priority value may be determined based on an associated PSSCH reception/transmission. Preferably in certain embodiments, the first UE may perform the one with the smaller priority value among the first priority value and the second priority value. Preferably in certain embodiments, when the first priority value is smaller than the second priority value, the first UE may perform the one or more standalone SL CSI-RS transmission(s)/reception(s)/measurement(s) (not perform the PSSCH/PSFCH transmission/reception) in the sidelink TTI. Preferably in certain embodiments, when the second priority value is smaller than the first priority value, the first UE may perform the PSSCH/PSFCH transmission/reception (not perform the one or more standalone SL CSI-RS transmission(s)/reception(s)/measurement(s)) in the sidelink TTI.

In method A3, the parameter/characteristic of standalone SL CSI-RS may be a first priority value associated with a specific SL logical channel associated with a second UE/destination, wherein the one or more standalone SL CSI-RS transmission(s) is performed for the second UE/destination. Preferably in certain embodiments, the first UE may have available sidelink data from the specific SL logical channel. Preferably in certain embodiments, the specific SL logical channel may be with a smallest priority value among SL logical channel(s) with available sidelink data associated with the second UE/destination. The first UE may determine a second priority value of the PSSCH/PSFCH transmission/reception. For the PSSCH transmission/reception comprising sidelink data from one or more SL logical channel(s) and/or SL MAC CE(s), the second priority value may be determined based on the one or more logical channel(s) and/or the SL MAC CE(s). For the PSFCH transmission/reception, the second priority value may be determined based on associated PSSCH reception/transmission. Preferably in certain embodiments, the first UE may perform the one with smaller priority value among the first priority value and the second priority value. Preferably in certain embodiments, when the first priority value is smaller than the second priority value, the first UE may perform the one or more standalone SL CSI-RS transmission(s) (not perform the PSSCH/PSFCH transmission/reception) in the sidelink TTI. Preferably in certain embodiments, when the second priority value is smaller than the first priority value, the first UE may perform the PSSCH/PSFCH transmission/reception (not perform the one or more standalone SL CSI-RS transmission(s)) in the sidelink TTI.

In method A4, the parameter/characteristic of standalone SL CSI-RS may be a first priority value indicated by a first sidelink control information, wherein the one or more standalone SL CSI-RS reception(s)/measurement(s) is scheduled/assigned/allocated/reserved by the first sidelink control information. The first UE may receive the first sidelink control information from a second UE. The first UE may determine a second priority value of the PSSCH/PSFCH transmission/reception. For the PSSCH transmission/reception comprising sidelink data from one or more SL logical channel(s) and/or SL MAC CE(s), the second priority value may be determined based on the one or more logical channel(s) and/or the SL MAC CE(s). For the PSFCH transmission/reception, the second priority value may be determined based on associated PSSCH reception/transmission. Preferably in certain embodiments, the first UE may perform the one with the smaller priority value among the first priority value and the second priority value. Preferably in certain embodiments, when the first priority value is smaller than the second priority value, the first UE may perform the one or more standalone SL CSI-RS reception(s)/measurement(s) (not perform the PSSCH/PSFCH transmission/reception) in the sidelink TTI. Preferably in certain embodiments, when the second priority value is smaller than the first priority value, the first UE may perform the PSSCH/PSFCH transmission/reception (not perform the one or more standalone SL CSI-RS reception(s)/measurement(s)) in the sidelink TTI.

In method A5, the parameter/characteristic of standalone SL CSI-RS may be a first priority threshold provided by configuration of the first sidelink resource pool or the first UE's sidelink configuration. The one or more standalone SL CSI-RS transmission(s)/reception(s)/measurement(s) is performed in the first sidelink resource pool. The first UE may determine a second priority value of the PSSCH/PSFCH transmission/reception. For the PSSCH transmission/reception comprising sidelink data from one or more SL logical channel(s) and/or SL MAC CE(s), the second priority value may be determined based on the one or more logical channel(s) and/or the SL MAC CE(s). For the PSFCH transmission/reception, the second priority value may be determined based on associated PSSCH reception/transmission. Preferably in certain embodiments, the first UE may perform the one at least based on the first priority threshold and the second priority value. Preferably in certain embodiments, when the second priority value is larger than the first priority threshold, the first UE may perform the one or more standalone SL CSI-RS transmission(s)/reception(s)/measurement(s) (not perform the PSSCH/PSFCH transmission/reception) in the sidelink TTI. Preferably in certain embodiments, when the second priority value is smaller than the first priority threshold, the first UE may perform the PSSCH/PSFCH transmission/reception (not perform the one or more standalone SL CSI-RS transmission(s)/reception(s)/measurement(s)) in the sidelink TTI.

In method A6, the parameter/characteristic of standalone SL CSI-RS may be that standalone SL CSI-RS has higher priority than the PSSCH/PSFCH. Preferably in certain embodiments, the standalone SL CSI-RS may or may not be associated with a first priority value. The first UE may determine a second priority value of the PSSCH/PSFCH transmission/reception. For the PSSCH transmission/reception comprising sidelink data from one or more SL logical channel(s) and/or SL MAC CE(s), the second priority value may be determined based on the one or more logical channel(s) and/or the SL MAC CE(s). For the PSFCH transmission/reception, the second priority value may be determined based on associated PSSCH reception/transmission. Preferably in certain embodiments, the first UE may determine to perform the one or more standalone SL CSI-RS transmission(s)/reception(s)/measurement(s) (not perform the PSSCH/PSFCH transmission/reception) in the sidelink TTI. The first UE may not consider/compare the second priority value and/or the first priority value. In other words, the type of standalone SL CSI-RS has a higher priority than the type of PSSCH/PSFCH.

In method A7, the parameter/characteristic of standalone SL CSI-RS may be the same or different at least based on kind/type of standalone SL CSI-RS. Preferably in certain embodiments, for each kind/type of standalone SL CSI-RS, associated parameter/characteristic of standalone SL CSI-RS may be determined based on any of the methods Al to A6. Preferably in certain embodiments, each kind/type of standalone SL CSI-RS may be associated with the same or different first priority value, respectively. Preferably in certain embodiments, the kind/type of standalone SL CSI-RS may comprise any of periodic standalone SL CSI-RS, semi-persistent standalone SL CSI-RS, aperiodic standalone SL CSI-RS, beam failure-related standalone SL CSI-RS, event/condition-triggered standalone SL CSI-RS (e.g., triggered by the first UE), and/or requested standalone SL CSI-RS (e.g., requested by a second UE). Preferably in certain embodiments, the aperiodic standalone SL CSI-RS may be with higher priority (e.g., with smaller associated priority value) than the periodic standalone SL CSI-RS and/or the semi-persistent standalone SL CSI-RS. Preferably in certain embodiments, the beam failure-related standalone SL CSI-RS may be with higher priority (e.g., with smaller associated priority value) than the periodic standalone SL CSI-RS and/or the semi-persistent standalone SL CSI-RS. Preferably in certain embodiments, the event/condition-triggered standalone SL CSI-RS may be with higher priority (e.g., with smaller associated priority value) than the periodic standalone SL CSI-RS and/or the semi-persistent standalone SL CSI-RS. Preferably in certain embodiments, the requested standalone SL CSI-RS may be with higher priority (e.g., with smaller associated priority value) than the periodic standalone SL CSI-RS and/or the semi-persistent standalone SL CSI-RS.

Preferably in certain embodiments, any one or any combined method above could be generated as a new method. Preferably in certain embodiments, different methods above may be used for different scenarios. For example, for Uplink (UL)/SL prioritization, SL CSI-RS transmission may need a priority while for SL/SL, TX/TX, TX/RX/RX/RX may not need SL CSI-RS. Preferably in certain embodiments, the UE transmits SL CSI-RS which is configured with priority higher than the first priority threshold and/or the UL channel/signal is with priority smaller than a second threshold. Alternatively, always prioritizing transmitting UL over SL, when SL is to transmit SL CSI-RS.

Preferably in certain embodiments, the overlapping TTI for a first channel/signal and a second channel/signal is on a same carrier, same sidelink resource pool, same SL BWP, and/or same frequency band.

Preferably in certain embodiments, the first channel/signal could be PSCCH, PSFCH, PSSCH, SL CSI-RS, or Synchronization Signal (SS)/PBCH.

Preferably in certain embodiments, the first channel/signal could be PUCCH, PUSCH, or Sounding Reference Signal (SRS).

Preferably in certain embodiments, the second channel/signal could be PSCCH, PSFCH, PSSCH, SL CSI-RS, or SS/PBCH.

Preferably in certain embodiments, the second channel/signal could be PUCCH, PUSCH, or SRS.

Preferably in certain embodiments, the first UE would utilize a second TX beam to perform the PSSCH/PSFCH transmission. Preferably in certain embodiments, the first UE would utilize a second RX beam to perform the PSSCH/PSFCH reception.

Preferably in certain embodiments, the first UE would utilize a first TX beam to perform the one or more standalone SL CSI-RS transmission(s). The first TX beam may be the same or different from the second TX beam.

Preferably in certain embodiments, the first UE would utilize a first RX beam to perform the one or more standalone SL CSI-RS reception(s)/measurement(s). The first RX beam may be the same or different from the second RX beam.

Alternatively, the first UE would utilize one or more first TX beam(s) to perform the one or more standalone SL CSI-RS transmission(s). The one or more first TX beams may or may not comprise the second TX beam.

Alternatively, the first UE would utilize one or more first RX beam(s) to perform the one or more standalone SL CSI-RS reception(s)/measurement(s). The one or more first RX beams may or may not comprise the second RX beam.

Preferably in certain embodiments, the first UE may perform one standalone SL CSI-RS transmission, of the one or more standalone SL CSI-RSs, via one TX beam.

Preferably in certain embodiments, the first UE may perform one standalone SL CSI-RS reception/measurement, of the one or more standalone SL CSI-RSs, via one RX beam.

Preferably in certain embodiments, the one or more standalone SL CSI-RS reception(s)/measurement(s) may be scheduled, assigned, allocated, or reserved by a first sidelink control information. Preferably in certain embodiments, the first sidelink control information may comprise a 1^{st} stage SCI of the first sidelink control information and a 2^{nd} stage SCI of the first sidelink control information. The 1^{st} stage SCI of the first sidelink control information is transmitted via PSCCH.

Preferably in certain embodiments, the first UE may transmit the first sidelink control information and perform the one or more SL CSI-RS transmission(s) in the same sidelink TTI. Preferably in certain embodiments, the first UE may transmit the first sidelink control information via a first TX beam. When the first sidelink control information indicates/sets repetition ON or the same TX beam, the first UE would utilize the first TX beam to perform the one or more standalone SL CSI-RS transmission(s). Preferably and/or alternatively, the first UE may transmit the first sidelink control information via a first TX beam. When the first sidelink control information indicates/sets repetition OFF or different TX beams, the first UE would utilize the one or more first TX beams (e.g., perform TX beam sweeping) to perform the one or more standalone SL CSI-RS transmission(s). The one or more first TX beams may comprise the first TX beam.

Preferably in certain embodiments, the first UE may receive the first sidelink control information and perform the one or more SL CSI-RS reception(s)/measurement(s) in the same sidelink TTI. Preferably in certain embodiments, the first UE may receive the first sidelink control information via a first RX beam. When the first sidelink control information (or a configuration or signaling) indicates/sets repetition ON or the same TX beam, the first UE would utilize the one or more first RX beams (e.g., perform RX beam sweeping) to perform the one or more standalone SL CSI-RS reception(s)/measurement(s). The one or more first RX beams may comprise the first RX beam. Preferably and/or alternatively, the first UE may receive the first sidelink control information via a first RX beam. When the first sidelink control information (or a configuration or signaling) indicates/sets repetition OFF or different TX beams, the first UE would utilize the first RX beam to perform the one or more standalone SL CSI-RS reception(s)/measurement(s).

Preferably in certain embodiments, the one or more standalone SL CSI-RSs are transmitted/multiplexed in non-overlapped symbol(s) (in time domain) in the sidelink TTI. Preferably in certain embodiments, the one or more standalone SL CSI-RSs are not transmitted/multiplexed in a frequency domain in the sidelink TTI. Preferably in certain embodiments, in the sidelink TTI, the one or more standalone SL CSI-RSs are transmitted/multiplexed in non-overlapped symbol(s) (in time domain) from transmission of the first sidelink control information. Preferably in certain embodiments, in the sidelink TTI, the one or more standalone SL CSI-RSs are transmitted/multiplexed in non-overlapped symbol(s) (in time domain) from transmission of (1^{st} stage SCI of) the first sidelink control information. Preferably in certain embodiments, in the sidelink TTI, the one or more standalone SL CSI-RSs are transmitted/multiplexed in non-overlapped symbol(s) (in time domain) from transmission of PSCCH.

Preferably in certain embodiments, when the first UE would transmit the first one or more standalone SL CSI-RS transmission(s) in a sidelink TTI and would transmit the second one or more standalone SL CSI-RS transmission(s) in the sidelink TTI, the first UE determines to perform either the first one or more standalone SL CSI-RS transmission(s) or the second one or more standalone SL CSI-RS transmission(s) in the sidelink TTI, at least based on the parameter/characteristic of the first one or more standalone SL CSI-RS transmission(s) and the second one or more standalone SL CSI-RS transmission(s). The first UE may not perform the other transmission(s) in the sidelink TTI. Any of the methods A1˜A7 may be utilized for determining/deriving the parameter/characteristic of the first one or more standalone SL CSI-RS transmission(s) and the second one or more standalone SL CSI-RS transmission(s). Preferably in certain embodiments, if/when priority of the first one or more standalone SL CSI-RS transmission(s) is the same as the priority of the second one or more standalone SL CSI-RS transmission(s), it may be upon the first UE's implementation to determine to perform which one.

Preferably in certain embodiments, when the first UE would receive/measure the first one or more standalone SL CSI-RS transmission(s) in a sidelink TTI and would receive the second one or more standalone SL CSI-RS transmission(s) in the sidelink TTI, the first UE determines to perform either the first one or more standalone SL CSI-RS reception(s)/measurement(s) or the second one or more standalone SL CSI-RS reception(s)/measurement(s) in the sidelink TTI, at least based on the parameter/characteristic of the first one or more standalone SL CSI-RS transmission(s) and the second one or more standalone SL CSI-RS transmission(s). The first UE may not perform the other reception(s) in the sidelink TTI. Any of the method A1˜A7 may be utilized for determining/deriving the parameter/characteristic of the first one or more standalone SL CSI-RS transmission(s) and the second one or more standalone SL CSI-RS transmission(s). Preferably in certain embodiments, if/when priority of the first one or more standalone SL CSI-RS transmission(s) is the same as the priority of the second one or more standalone SL CSI-RS transmission(s), it may be upon the first UE's implementation to determine to perform which one.

Preferably in certain embodiments, when the first UE would receive/measure the first one or more standalone SL CSI-RS transmission(s) in a sidelink TTI and would transmit the second one or more standalone SL CSI-RS transmission(s) in the sidelink TTI, the first UE determines to perform either the first one or more standalone SL CSI-RS reception(s)/measurement(s) or the second one or more standalone SL CSI-RS transmission(s) in the sidelink TTI, at least based on the parameter/characteristic of the first one or more standalone SL CSI-RS transmission(s) and the second one or more standalone SL CSI-RS transmission(s). The first UE may not perform the other in the sidelink TTI. Any of the method A1˜A7 may be utilized for determining/deriving the parameter/characteristic of the first one or more standalone SL CSI-RS transmission(s) and the second one or more standalone SL CSI-RS transmission(s). Preferably in certain embodiments, if/when the priority of the first one or more standalone SL CSI-RS transmission(s) is the same as the priority of the second one or more standalone SL CSI-RS transmission(s), it may be upon the first UE's implementation to determine to perform which one.

### Concept B

The first UE may have/receive configuration of the network scheduling mode (e.g., mode 1) for acquiring/obtaining sidelink resource(s). The first UE may acquire/obtain the sidelink resource(s) scheduled/allocated via SL grant(s) from the network node. The sidelink resource(s) are utilized for sidelink communication in the second one or more sidelink resource pools in the one sidelink BWP or the one sidelink carrier/cell.

The first UE may trigger or request to perform one or more standalone SL CSI-RS transmission(s) in a sidelink TTI. The one or more standalone SL CSI-RS transmission(s) is performed in the first sidelink resource pool. Preferably in certain embodiments, the triggered/requested standalone SL CSI-RS transmission(s) may be performed for/to a second UE/destination (e.g., for unicast or groupcast). Preferably and/or alternatively, the triggered/requested standalone SL CSI-RS transmission(s) may be performed for/to nearby UEs (e.g., for broadcast).

For acquiring/obtaining one or more sidelink resources for performing one or more standalone SL CSI-RS transmission(s), there are some methods:

In method B1, the trigger/request/need of standalone SL CSI-RS transmission(s) may trigger a buffer status report to the network node. More specifically, the trigger/request/need of standalone SL CSI-RS transmission(s) may trigger a sidelink buffer status report to the network node. In other words, the (regular) sidelink buffer status report could be triggered in response to the trigger/request of standalone SL CSI-RS transmission(s). Preferably in certain embodiments, when the first UE requires to transmit the standalone SL CSI-RS transmission(s), and when the first UE has no available sidelink resources for the standalone SL CSI-RS transmission(s), the first UE may trigger the sidelink buffer status report to the network node. Preferably in certain embodiments, the sidelink buffer status report may indicate the trigger/request/need of the standalone SL CSI-RS transmission(s). When/after the network node receives the sidelink buffer status report, the network node may schedule one or more sidelink resource(s) via sidelink grant or configuration to the first UE. The first UE may utilize the one or more sidelink resource(s) for performing the one or more standalone SL CSI-RS transmission(s).

In one embodiment, the standalone SL CSI-RS transmission(s) does not belong to an SL logical channel (e.g., in MAC layer). Preferably in certain embodiments, the standalone SL CSI-RS transmission(s) may be sidelink reference signal (e.g., in physical layer). Preferably in certain embodiments, the sidelink buffer status report may indicate the trigger/request/need of the standalone SL CSI-RS transmission(s).

In one embodiment, the standalone SL CSI-RS transmission(s) may belong to or associate with an SL logical channel (e.g., in MAC layer) associated with the second UE/destination. Preferably in certain embodiments, the sidelink logical channel may be (pre-)configured/assigned/associated with a first priority value. More specifically, the sidelink logical channel may be able to trigger the sidelink buffer status report to the network node. Preferably in certain embodiments, the triggered sidelink buffer status report may indicate/count a buffer size information of the sidelink logical channel. The buffer size information may comprise a buffer size for the standalone SL CSI-RS transmission(s). Preferably in certain embodiments, the buffer size for the standalone SL CSI-RS transmission(s) may be (pre)configured or specified. Preferably in certain embodiments, the buffer size for the standalone SL CSI-RS transmission(s) may be determined based on a (required/expected/intended) bandwidth or frequency resources of the standalone SL CSI-RS transmission(s).

In one embodiment, the standalone SL CSI-RS transmission(s) may belong to or associate with an (virtual) SL logical channel (e.g., in MAC layer). Preferably in certain embodiments, the (virtual) sidelink logical channel may be (pre-)configured/assigned/associated with a first priority value. More specifically, the (virtual) sidelink logical channel may be able to trigger the sidelink buffer status report to the network node. Preferably in certain embodiments, the triggered sidelink buffer status report may indicate/count a buffer size information of the (virtual) sidelink logical channel. The buffer size information may comprise a buffer size for the standalone SL CSI-RS transmission(s). Preferably in certain embodiments, the buffer size may be (pre)configured or specified or fixed. Preferably in certain embodiments, the buffer size may be determined based on a (required/expected/intended) bandwidth or frequency resources of the standalone SL CSI-RS transmission(s). Preferably in certain embodiments, the triggered sidelink buffer status report may indicate/count a buffer size of the (virtual) sidelink logical channel as zero.

Preferably in certain embodiments, when the first UE does not have uplink resources for delivering/transmitting the sidelink buffer status report, the sidelink buffer status report may trigger a (sidelink) Scheduling Request (e.g., SR) from the first UE to the network node. When the network node receives/detects the (sidelink) scheduling request from the first UE, the network node may schedule an uplink resource to the first UE, and the first UE may utilize the uplink resource for delivering/transmitting the sidelink buffer status report to the network.

Preferably in certain embodiments, when the first UE has available uplink resources for delivering/transmitting the sidelink buffer status report, the first UE delivers/transmits the sidelink buffer status report via the uplink resource.

Preferably in certain embodiments, when the first UE has available sidelink resources for performing the one or more standalone SL CSI-RS transmission(s), the first UE may not trigger the sidelink buffer status report to the network node. The first UE may utilize the available sidelink resource for performing the standalone SL CSI-RS transmission(s).

In method B2, the trigger/request/need of a standalone SL CSI-RS transmission(s) may trigger a scheduling request to the network. More specifically, the trigger/request/need of sidelink standalone SL CSI-RS transmission(s) may trigger sidelink scheduling request to the network node. Preferably in certain embodiments, the trigger/request/need of the standalone SL CSI-RS transmission(s) may or may not trigger a sidelink buffer status report to the network node. Preferably in certain embodiments, when the first UE requires to transmit the standalone SL CSI-RS transmission(s), and when the first UE has no available sidelink resources for the standalone SL CSI-RS transmission(s)), the first UE may trigger the sidelink scheduling request to the network. When/after the network node receives/detects the sidelink scheduling request, the network node may schedule one or more sidelink resource(s) via sidelink grant or configuration to the first UE. The first UE may utilize the one or more sidelink resource(s) for performing the standalone SL CSI-RS transmission(s).

Preferably in certain embodiments, the standalone SL CSI-RS transmission(s) does not belong to an SL logical channel (e.g., in MAC layer). Preferably in certain embodiments, the standalone SL CSI-RS transmission(s) may be a sidelink reference signal (e.g., in physical layer). Preferably in certain embodiments, the sidelink scheduling request may indicate the trigger/request/need of the standalone SL CSI-RS transmission(s). Preferably in certain embodiments, the standalone SL CSI-RS transmission(s) does not correspond to a sidelink reporting signaling (e.g., SL CSI report, SL Inter-UE Coordination (IUC) report, SL Discontinuous Reception (DRX) command, SL IUC request).

Preferably in certain embodiments, the first UE has/receives, from the network node, configuration of at least one SR (scheduling request) configuration for transmitting the sidelink scheduling request. Preferably in certain embodiments, the first UE has/receives, from the network node, configuration of at least one SR (scheduling request) configuration for standalone SL CSI-RS. Preferably in certain embodiments, the SR configuration for standalone SL CSI-RS may be associated/configured/assigned with an SR configuration identity (index). Preferably in certain embodiments, the sidelink scheduling request is transmitted via PUCCH.

Preferably in certain embodiments, the SR configuration for the triggered/requested standalone SL CSI-RS transmission(s) may be associated with the second UE/destination. Preferably in certain embodiments, for the triggered/requested standalone SL CSI-RS transmission(s) to/for the second UE/destination, the first UE may determine uplink resource, for transmitting the sidelink scheduling request, via one SR configuration associated with the second UE/destination. The first UE may determine/derive the one SR configuration at least based on (association with) the second UE/destination.

Preferably in certain embodiments, the first UE may (expect/trigger/request to) perform the one or more standalone SL CSI-RS transmissions via one or more first TX beam(s) in the sidelink TTI. Preferably in certain embodiments, the first UE may transmit a first sidelink control information, via one first TX beam, in the one sidelink TTI, for scheduling/allocating/reserving the one or more SL CSI-RS transmission(s). Preferably in certain embodiments, the SR configuration for the triggered/requested standalone SL CSI-RS transmission(s) may be associated with the one or more first TX beam(s). Preferably in certain embodiments, for the triggered/requested standalone SL CSI-RS transmission(s) to/for the second UE/destination, the first UE may determine an uplink resource, for transmitting the sidelink scheduling request, via one SR configuration associated with the one or more first TX beam(s). The first UE may determine/derive the one SR configuration at least based on (association with) the one or more first TX beam(s). Preferably and/or alternatively, the SR configuration for the triggered/requested standalone SL CSI-RS transmission(s) may be associated with the one first TX beam. Preferably in certain embodiments, for the triggered/requested standalone SL CSI-RS transmission(s) to/for the second UE/destination, the first UE may determine the uplink resource, for transmitting the sidelink scheduling request, via one SR configuration associated with the one first TX beam. The first UE may determine/derive the one SR configuration at least based on (association with) the one first TX beam.

The sidelink scheduling request may be shared by one or more signaling. The one or more signaling could be sidelink reporting signaling, or standalone SL CSI-RS. When the UE in a first timing triggers sidelink CSI reporting, the UE transmits the sidelink scheduling request to a network node. When the UE in a second timing needs to transmit standalone SL CSI-RS, the UE transmits the sidelink scheduling request to a network node. Periodic PUCCH resource is associated with the sidelink scheduling request (associated with one sidelink scheduling request ID). Alternatively, the sidelink scheduling request corresponds to standalone SL CSI-RS and another sidelink scheduling request (with different scheduling request ID) corresponds to sidelink reporting signaling.

Preferably in certain embodiments, the SR configuration identity (index) may not be associated with sidelink MAC CE. Additionally and/or alternatively, the SR configuration identity (index) associated with standalone SL CSI-RS could be associated with (or shared with) one or more sidelink logical channels. Additionally and/or alternatively, the SR configuration associated with standalone SL CSI-RS could be associated with an SR configuration for SL MAC CE (e.g., inter-coordination MAC CE and/or CSI reporting MAC CE and/or SL LBT failure MAC CE and/or SL DRX command MAC CE).

Additionally and/or alternatively, at least one SR configuration could be associated with (the need of transmitting) the sidelink reporting signaling. Preferably in certain embodiments, an SR configuration identity (index) may be associated with standalone SL CSI-RS (only). Preferably in certain embodiments, the SR configuration identity (index) may not be associated with sidelink logical channel.

Preferably in certain embodiments, the sidelink scheduling request may indicate the trigger/request/need of the standalone SL CSI-RS transmission(s). Preferably in certain embodiments, the sidelink scheduling request may indicate a need of a specific size of sidelink resource. Preferably in certain embodiments, the specific size comprises at least (required/expected/intended) bandwidth or frequency resources of the standalone SL CSI-RS transmission(s). The specific size may be a fixed/specified or (pre-)configured value.

Preferably in certain embodiments, if the first UE also has a (regular) sidelink buffer status report to the network, the sidelink scheduling request may indicate a need of a larger/normal size of sidelink resource.

Preferably in certain embodiments, the first UE transmits the sidelink scheduling request to the network node when the first UE does not have available uplink resources for performing PUSCH transmission. Preferably and/or alternatively, the first UE transmits the sidelink scheduling request to the network node even when the first UE has available uplink resources for performing PUSCH transmission.

Preferably in certain embodiments, if/when the first UE has available sidelink resources for performing the one or more standalone SL CSI-RS transmission(s), the first UE may not trigger/transmit the sidelink scheduling request to the network node. The first UE may utilize the available sidelink resource for performing the standalone SL CSI-RS transmission(s).

In method B3, if/when the first UE does not have available sidelink resources for performing the one or more standalone SL CSI-RS transmission(s), the first UE may select one or more sidelink resource(s) in an exceptional pool and perform the one or more standalone SL CSI-RS transmission(s) via the selected sidelink resource. More specifically, when the first UE has/receives a configuration of a network scheduling mode for acquiring/obtaining sidelink resource(s), the first UE can select the one or more sidelink resources in the exceptional pool for performing the one or more standalone SL CSI-RS transmission(s).

Preferably in certain embodiments, the standalone SL CSI-RS transmission(s) does not belong to an SL logical channel (e.g., in MAC layer). Preferably in certain embodiments, the standalone SL CSI-RS transmission(s) may be a sidelink reference signal (e.g., in physical layer).

Preferably in certain embodiments, the selected one or more sidelink resource(s) may be with a single sub-channel (in frequency domain). Preferably and/or alternatively, the selected one or more sidelink resource(s) may be with a specific size (in frequency domain). Preferably in certain embodiments, the specific size comprises at least (required/expected/intended) bandwidth or frequency resources of the standalone SL CSI-RS transmission(s). The specific size may be a fixed/specified or (pre-)configured value.

Preferably in certain embodiments, if/when the first UE has available sidelink resources for performing the one or more standalone SL CSI-RS transmission(s), the first UE may not select the one or more sidelink resources in the exceptional pool for performing the standalone SL CSI-RS transmission(s). The first UE may utilize the available sidelink resource for performing the standalone SL CSI-RS transmission(s).

Preferably in certain embodiments, the first UE would randomly select the one or more sidelink resources in the exceptional pool.

Preferably in certain embodiments, the first UE has/receives a configuration of the exceptional pool.

Preferably in certain embodiments, the exceptional pool may provide sidelink resource(s) by which the first UE performs sidelink communication and/or the standalone SL CSI-RS transmission(s) in exceptional conditions. The exceptional conditions may contain/comprise the case where the standalone SL CSI-RS transmission(s) is triggered/requested and the first UE does not have available sidelink resources (in the first (one or more) sidelink resource pool) for performing the standalone SL CSI-RS transmission(s). Preferably in certain embodiments, the first (one or more) sidelink resource pool does not comprise the exceptional pool

### Concept C

The first UE may have/receive configuration of UE (autonomous) selection mode (e.g., mode 2) for acquiring/obtaining sidelink resource(s).

Preferably in certain embodiments, for performing sidelink data transmission(s) (e.g., PSSCH and corresponding PSCCH) via a second TX beam, the first UE may perform a second sensing-based resource selection for selecting one or more second sidelink resource(s) in the second sidelink resource pool. Preferably in certain embodiments, based on a sensing result in the second sidelink resource pool, the first UE may determine a second set of identified/valid candidate resources and select the one or more second sidelink resource(s) from the second set of identified/valid candidate resources. Preferably in certain embodiments, the first UE may determine the second set of identified/valid candidate resources at least based on the sensing result via one (or more) second RX beam. Preferably in certain embodiments, the first UE may determine the second set of identified/valid candidate resources with or without basing on the sensing result via RX beams other than the one (or more) second RX beam. Preferably in certain embodiments, the one (or more) second RX beam may be determined/derived from the second TX beam. Preferably in certain embodiments, the one (or more) second RX beam may comprise/cover the second TX beam in spatial domain. Preferably in certain embodiments, the one (or more) second RX beam and the second TX beam may be associated/correspond with a same sidelink reference signal or a same antenna port. Preferably in certain embodiments, for determining the second set of identified/valid candidate resources, the first UE may exclude some candidate resources based on received SCI(s) via one (or more) second RX beam. Preferably in certain embodiments, the first UE may trigger, in a second trigger timing, a second procedure to determine/derive the second set of identified/valid candidate resources. The received SCI(s) are received by the first UE within a second sensing window associated with the second trigger timing. The first UE may perform sidelink data transmission(s) on the selected one or more second sidelink resources.

Comparing that sidelink data transmission (e.g., PSSCH and corresponding PSCCH) in one sidelink TTI is transmitted/received via the second TX beam, the first UE may perform one or more standalone SL CSI-RS transmission(s), via one or more first TX beams, in one sidelink TTI. Preferably in certain embodiments, for performing the one or more standalone SL CSI-RS transmission(s) via one or more first TX beam(s), the first UE may perform a first sensing-based resource selection for selecting one or more first sidelink resource(s) in the first sidelink resource pool. Preferably in certain embodiments, based on a sensing result in the first sidelink resource pool, the first UE may determine a first set of identified/valid candidate resources and select the one or more first sidelink resource(s) from the first set of identified/valid candidate resources. The first UE may perform the one or more standalone SL CSI-RS transmission(s) on the selected one or more first sidelink resources.

In one embodiment C1, the one or more first TX beams may mean one first TX beam. The first UE may perform the one or more standalone SL CSI-RS transmission(s), via the one first TX beam. Preferably in certain embodiments, the first UE may transmit a first sidelink control information, via the one first TX beam in the same one sidelink TTI, for scheduling/allocating/reserving the one or more SL CSI-RS transmission(s). Preferably in certain embodiments, the first sidelink control information may indicate/set repetition ON or the same TX beam.

Preferably in certain embodiments, the first UE may determine the first set of identified/valid candidate resources based on a sensing result via one (or more) first RX beam. Preferably in certain embodiments, the first UE may determine the first set of identified/valid candidate resources with or without basing on the sensing result via RX beams other than the one (or more) first RX beam. Preferably in certain embodiments, the one (or more) first RX beam may be determined/derived from the one first TX beam. Preferably in certain embodiments, the one (or more) first RX beam may comprise/cover the one first TX beam in spatial domain. Preferably in certain embodiments, the one (or more) first RX beam and the one first TX beam may be associated/correspond with a same sidelink reference signal or a same antenna port. Preferably in certain embodiments, for determining the first set of identified/valid candidate resources, the first UE may exclude some candidate resources based on received SCI(s) via the one (or more) first RX beam. Preferably in certain embodiments, the first UE may trigger, in a first trigger timing, a first procedure to determine/derive the first set of identified/valid candidate resources. The received SCI(s) are received by the first UE within a first sensing window associated with the first trigger timing.

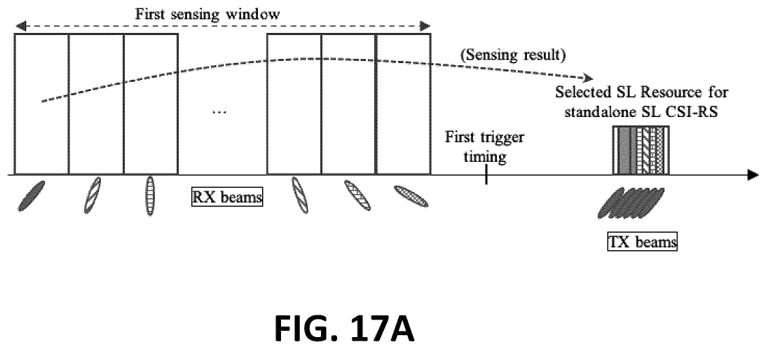

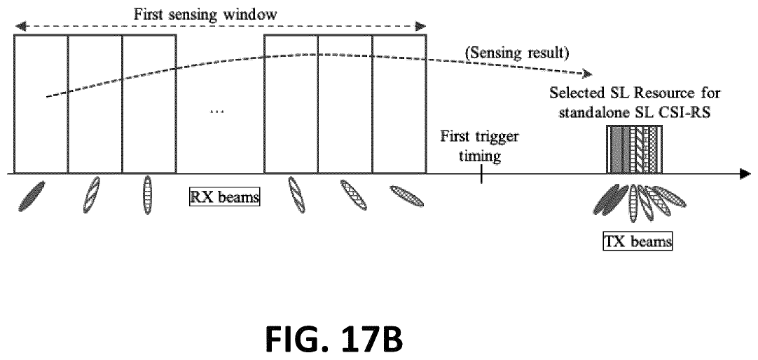

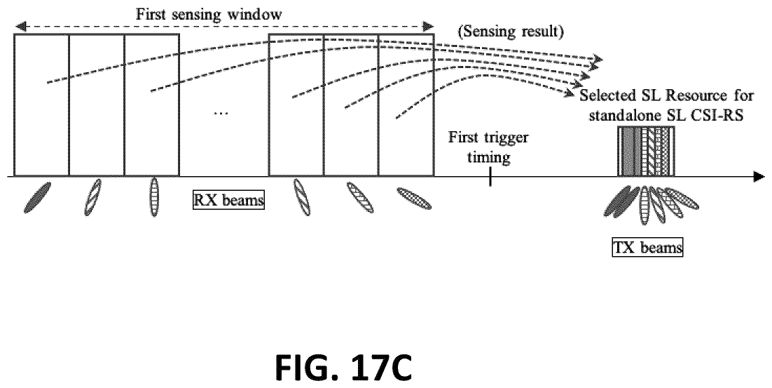

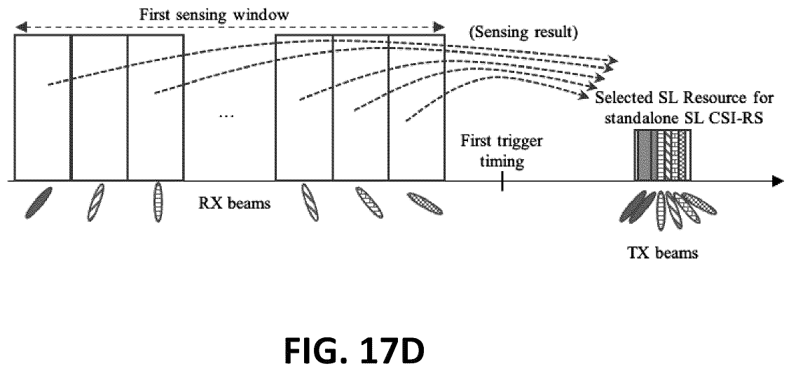

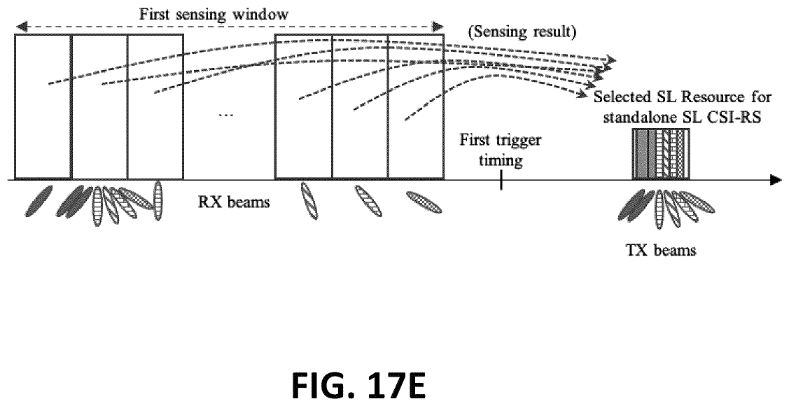

As an instance shown in FIG. 17A, the first UE may transmit the sidelink control information (shown in first gray-bar) and perform 5 SL CSI-RS transmissions (shown in the following 5 bars). The first UE may perform them via the same one TX beams (shown as gray TX beam). For selecting the SL resource, the first UE may utilize the sensing result or received SCI(s) via the gray RX beam. The first UE may not utilize the sensing result or received SCI(s) via other RX beams.

In FIG. 17A, the first UE determine sidelink resource for standalone SL CSI-RS transmission based on the gray RX beam sensing result. In one embodiment, receiving UE determines (or fine tune) its TX beam for one beam pair based on the transmitter UE's SL CSI-RS transmission with a same beam. In this example, when a second UE receives the SCI in a TTI from the first UE and the SCI provides information of a plurality of standalone SL CSI-RSs, the second UE receives corresponding standalone SL CSI-RSs on corresponding occasion via a different RX beam. From the receiving UE's point of view (e.g., the second UE), the second UE can determine the TX beam associated with the first UE based on a highest quality using one RX beam for reception. The second UE has capability of beam correspondence or there is beam correspondence between one TX beam and the RX beam. In one example, the receiver UE may buffer or receive a time duration via one same RX beam. Start timing for the time duration could be 1-st symbol in one TTI or 1-st sidelink symbol in one TTI or 1-st symbol of PSCCH in one TTI (in a sidelink resource pool). Length of the time duration may correspond to decoding time for SCI or the receiving UE getting information of the plurality of SL CSI-RSs (in one TTI). At least one SL CSI-RS transmission occasion is within the time duration. At most one SL CSI-RS transmission occasion is within the time duration. Length of time duration may correspond to X symbols. Preferably in certain embodiments, X could be 1, 2, 3, 4, 5, 6, 7. The second UE may have its beam monitoring pattern for monitoring SCI in a sidelink resource pool. For example, when the second UE has RX beam {1˜4}, the second UE will monitor the sidelink resource pool based on RX beam {1, 2, 3, 4} cyclically. For TTI monitored by RX beam 1, the second UE receives or buffers sidelink symbol based on RX beam 1 (at least for the time duration). When the second UE determines this TTI is associated with the plurality of SL CSI-RSs, the second UE receives remaining sidelink symbols via different RX beams. Based on SCI with source ID (which could be L1 or L2), the second UE could determine the TX beam and/or the RX beam for which one pairs to which UE.

In one embodiment C2, the one or more first TX beams may mean multiple first TX beams. The first UE may perform the one or more standalone SL CSI-RS transmission(s), via the multiple first TX beam. Preferably in certain embodiments, the first UE may transmit a first sidelink control information, via one first TX beam in the same one sidelink TTI, for scheduling/allocating/reserving the one or more SL CSI-RS transmission(s). Preferably in certain embodiments, the multiple first TX beam may comprise the one first TX beam. Preferably in certain embodiments, the first sidelink control information may indicate/set repetition OFF or a different TX beam.

Preferably in certain embodiments, the first UE may determine the first set of identified/valid candidate resources based on a sensing result via one (or more) first RX beam. Preferably in certain embodiments, the first UE may determine the first set of identified/valid candidate resources with or without basing on the sensing result via the RX beams other than the one (or more) first RX beam. Preferably in certain embodiments, the one (or more) first RX beam may be determined/derived from the one first TX beam. Preferably in certain embodiments, the one (or more) first RX beam may comprise/cover the one first TX beam in spatial domain. Preferably in certain embodiments, the one (or more) first RX beam and the one first TX beam may be associated/correspond with a same sidelink reference signal or a same antenna port. Preferably in certain embodiments, for determining the first set of identified/valid candidate resources, the first UE may exclude some candidate resources based on received SCI(s) via the one (or more) first RX beam. Preferably in certain embodiments, the first UE may trigger, in a first trigger timing, a first procedure to determine/derive the first set of identified/valid candidate resources. The received SCI(s) are received by the first UE within a first sensing window associated with the first trigger timing.

As an instance shown in FIG. 17B, the first UE may transmit the sidelink control information (shown in first gray-bar) and perform 5 SL CSI-RS transmissions (shown in the following 5 bars). The first UE may perform the 5 SL CSI-RS transmissions via different TX beams. Preferably in certain embodiments, the first UE may transmit the first/initial SL CSI-RS transmission via the same TX beam as transmission of the sidelink control information. For selecting the SL resource, the first UE may utilize the sensing result or received SCI(s) via the gray RX beam (i.e., corresponding to the TX beam of the sidelink control information). The first UE may not utilize the sensing result or received SCI(s) via other RX beams.

In one embodiment C3, the one or more first TX beams may mean multiple first TX beams. The first UE may perform the one or more standalone SL CSI-RS transmission(s), via the multiple first TX beam. Preferably in certain embodiments, the first UE may transmit a first sidelink control information, via one first TX beam in the same one sidelink TTI, for scheduling/allocating/reserving the one or more SL CSI-RS transmission(s). Preferably in certain embodiments, the multiple first TX beam may comprise the one first TX beam. Preferably in certain embodiments, the first sidelink control information may indicate/set repetition OFF or a different TX beam.

Preferably in certain embodiments, the first UE may determine the first set of identified/valid candidate resources based on the sensing result via multiple first RX beams. Preferably in certain embodiments, the first UE may determine the first set of identified/valid candidate resources with or without basing on the sensing result via RX beams other than the multiple first RX beams. Preferably in certain embodiments, the multiple first RX beams may be determined/derived from the multiple first TX beams. Preferably in certain embodiments, the multiple first RX beams may comprise/cover the multiple first TX beams in spatial domain. Preferably in certain embodiments, each of the multiple first RX beams may comprise/cover one of the multiple first TX beams in spatial domain. Preferably in certain embodiments, the multiple first RX beams and the multiple first TX beams may be associated/correspond with the same set of sidelink reference signals or the same set of antenna ports. Preferably in certain embodiments, each of the multiple first RX beams may be respectively associated/correspond with a same sidelink reference signal or a same antenna port with each of the multiple first TX beams. Preferably in certain embodiments, for determining the first set of identified/valid candidate resources, the first UE may exclude some candidate resources based on received SCI(s) via the multiple first RX beams. Preferably in certain embodiments, the first UE may trigger, in a first trigger timing, a first procedure to determine/derive the first set of identified/valid candidate resources. The received SCI(s) are received by the first UE within a first sensing window associated with the first trigger timing.

As an instance shown in FIG. 17C, the first UE may transmit the sidelink control information (shown in first gray-bar) and perform 5 SL CSI-RS transmissions (shown in following 5 bars). The first UE may perform the 5 SL CSI-RS transmissions via different TX beams. Preferably in certain embodiments, the first UE may transmit the first/initial SL CSI-RS transmission via the same TX beam as transmission of the sidelink control information. For selecting the SL resource, the first UE may utilize the sensing result or received SCI(s) via different RX beams (i.e., corresponding to the different TX beams of the sidelink control information and the 5 SL CSI-RS transmissions). The first UE may not utilize the sensing result or received SCI(s) via other RX beams.

In one embodiment, the first UE determines using which TX beam for beam sweeping based on a reference TX beam in a beam group. Preferably in certain embodiments, beam group is determined or generated based on beamforming/antenna gain distortion within a threshold. Preferably in certain embodiments, the first UE uses a reference beam for determining sidelink resource for sidelink transmission. In one example, as shown in FIG. 17D, the gray RX beam is determined as the reference beam for determining sidelink resource. The beam group could be gray RX beam, and RX beam(s) other than a RX beam (which is monitored in the next TTI of gray RX beam, which is just an example for generating/determining a beam group). Preferably in certain embodiments, the first UE may take into account the sensing result associated with the RX beam in the beam group. Preferably in certain embodiments, the first UE merely takes the sensing result associated with the reference beam in the beam group. Preferably in certain embodiments, for TTI comprising a plurality of SL CSI-RS transmission occasions, the TX UE determines whether to transmit on the resource on the TTI using the sensing result associated with one or more reference beams (for each beam group).

In one embodiment, for a TTI the first UE using more than one RX beam for monitoring, the sensing result for the TTI may be determined to associate with which RX beam for monitoring PSCCH/SCI. Preferably in certain embodiments, for a TTI with the first UE using more than one RX beam for monitoring, the sensing result for the TTI may be determined to associate with the more than one beam for such TTI. No matter if the first UE determines sidelink resource for PSSCH transmission and/or standalone SL CSI-RS transmission, the first UE determines the sensing result of TTI (comprising more than one TTIs) being associated with one RX beam or more than one RX beam. For example, in FIG. 17E, for TTI comprising more than one RX beam for monitoring (e.g., second TTI in the first sensing window), the UE would consider the sensing result in the second TTI is associated with gray RX beam (e.g., one RX beam for monitoring SCI) or the sensing result is associated with more than one RX beam(s). Preferably in certain embodiments, based on the sensing result in the second TTI, the first UE could exclude the sidelink resource in TTI associated with the sensing result in the second TTI.

Preferably in certain embodiments, for FIGS. 17A-17E, the gray beam may be determined based on the currently paired beam to a target UE/destination. Preferably in certain embodiments, for another example, the gray TX beam may be determined based on the reference beam in a beam group. Preferably in certain embodiments, the beam group comprises the currently paired beam to a target UE/destination. Preferably in certain embodiments, based on whether the destination is the target UE/destination or not, the first UE determines the gray RX beam as the TX beam for determining sidelink resources for transmission. Preferably in certain embodiments, if at least one sensing result associated with the beam marked with a horizontal line (in the second TTI) is not qualified (e.g., larger than a threshold), the first UE exclude sidelink resource in TTI is associated with (and/or reserved by) the second TTI. Alternatively, the first UE exclude sidelink resource in TTI is associated with (and/or reserved by) the second TTI, wherein symbol(s) associated with the beam are marked with horizontal line. For other TTI(s) in the sensing window, the whole TTI is associated with one sensing result associated with one RX beam. Alternatively and/or preferably, the first UE could perform a weighting procedure for more than one sensing result in the second TTI in the first sensing window in FIG. 17E. The weighting factor may be determined based on beamforming/antenna gain of (at least) two beams (with one RX beam is used for receiving SCI and the other for receiving standalone CSI-RS). Alternatively, the second TTI does not have periodic reservation. Preferably in certain embodiments, the first UE excludes the sensing result in TTI comprising using more than one RX beam for monitoring (e.g., the second TTI in the first sensing window).

Alternatively, for FIGS. 17A-17E, when the first UE performs sensing during the first sensing window and receives a TTI via the gray RX beam, and the TTI is with standalone SL CSI-RS is transmitted via other UE(s) (e.g., which could be unicast pair UE or group UE or broadcast UE). The first UE receives SCI via the the gray RX beam, and determines RSRP based on Demodulation Reference Signal (DMRS) of PSCCH. The first UE does not determine RSRP based on DMRS of PSSCH. The first UE does not determine RSRP based on each SL CSI-RS transmission occasion within a TTI monitored by the first UE using the gray RX beam. Alternatively, the first UE determines RSRP based on DMRS of one or more SL CSI-RS transmission occasions within a TTI monitored by the first UE using the gray RX beam. (When the first UE determines RSRP for the TTI) The first UE may perform weighting for RSRP measurement associated with each SL CSI-RS transmission occasion in the TTI. The weighting factor for one or more SL CSI-RS transmission occasions may be determined based on transmitting the UE's indication (e.g., from the second UE). The second UE may determine one or more weighting factors for one or more CSI-RS transmission occasions based on beamforming/antenna gain between the beam associated with PSCCH in the TTI and the beam associated with SL CSI-RS transmission occasion in the TTI. Alternatively, the first UE would consider no sensing result for such TTI.

Preferably in certain embodiments, the one or more standalone SL CSI-RS transmission(s) may be performed for/to a second UE/destination (e.g., for unicast or groupcast). Preferably in certain embodiments or alternatively, the triggered/requested standalone SL CSI-RS transmission(s) may be performed for/to nearby UEs (e.g., for broadcast).

Alternatively, one SL CSL-RS transmission occasion may comprise PSCCH and SL CSI-RS. In one example, as shown in FIG. 15A, symbol #5 #6 corresponds to one SL CSI-RS transmission occasion, symbol #7 symbol #8 corresponds to a second one SL CSI-RS transmission occasion and so on. SL CSI-RS in one SL CSL-RS transmission occasion may have a specific type SCI transmitted in the one SL CSI-RS transmission occasion. The specific type SCI comprises priority, frequency resource assignment, time resource assignment, resource reservation period, DMRS pattern, number of SL-CSI RS ports, source ID (e.g., L1 or L2), or destination ID (e.g., L1 or L₂). Preferably in certain embodiments, the specific type SCI is carried/delivered by PSCCH or PSSCH. Alternatively and/or preferably, for TTI comprising a plurality of SL CSI-RS transmission occasions, the TTI does not comprise resources for 2-nd state SCI. In one example, 2-nd stage SCI may be repeatedly transmitted in each SL CSI-RS transmission occasion.

### Concept D: SL CSI-RS Resources (Pool) are Configured Separately in Time Domain/Frequency Domain/Spatial Domain From SL Data/Feedback Resources

Concept D is that a UE could be configured with a first one or more resource(s) for standalone SL CSI-RS transmission(s)/reception(s)/measurement(s). The first one or more resource(s) could be (associated with or indicated in) a resource pool configuration (for transmitting/receiving, measuring standalone SL CSI-RS). (Each of) The first one or more resource(s) may not overlap with (any) second one or more resource(s) for SL data and/or feedback and/or control transmission/reception. For example, the UE could be configured with a first resource pool (dedicated for) indicating first resource(s) for standalone SL CSI-RS transmission/reception/measurement. The UE could be configured with a second resource pool indicating second resource(s) for SL data/feedback/control transmission. For any resource in/of the first resource(s), the resource may not overlap with any resource in/of the second resource(s).

SL control transmission could contain PSCCH transmission (e.g., SCI) indicating/scheduling PSSCH transmission (and may not be standalone SL CSI-RS).

Additionally and/or alternatively, when performing resource pool (re) selection, the UE may not select a resource pool for SL data transmission if or when the resource pool is associated with/contains resources overlapping with resource(s) for standalone SL CSI-RS transmission/reception/measurement (when the UE triggers an SL CSI-RS transmission/measurement or is monitoring standalone SL CSI-RS).

Additionally and/or alternatively, a network node may not configure/provide a UE a first resource(s) for standalone SL CSI-RS transmission that overlaps with (any) resource(s) configured/provided to the UE for SL data and/or feedback and/or control transmission/reception.

When a first resource and a second resource overlap, the first resource and the second resource overlap in time domain. Additionally and/or alternatively, when a first resource and a second resource overlap, the first resource and the second resource overlap in frequency domain (e.g., a same BWP, resource block(s), and/or a same SL carrier frequency). Additionally and/or alternatively, when a first resource and a second resource overlap, the first resource and the second resource overlaps in spatial domain. Additionally and/or alternatively, when the first resource and the second resource overlaps, the UE may not be able to perform transmissions via the first resource and the second resource simultaneously.

### Concept E: SL CSI-RS Gap for Measuring SL CSI-RS

Concept E is that a UE could be configured with a gap for measuring/receiving/transmitting SL CSI-RS. Alternatively and/or additionally, the UE could be configured with a transmission gap for (prioritizing) transmitting standalone SL CSI-RS and a reception gap for (prioritizing) receiving/measuring standalone SL CSI-RS. The gap could be a (recurring or periodic) time period. The gap could be derived based on a repetition period and/or an offset. The gap could be configured, by a network, via an RRC message (e.g., SL measurement gap configuration). During the gap, the UE may not perform SL data transmission and/or SL feedback transmission and/or SL control transmission and/or SL data reception (except standalone SL CSI-RS). Additionally and/or alternatively, the UE may not perform PSSCH, PSCCH, and/or PSFCH transmission (except standalone SL CSI-RS transmission) during the gap. Additionally and/or alternatively, the UE could deprioritize PSSCH, PSCCH, and/or PSFCH transmission (e.g., perform standalone SL CSI-RS transmission and does not perform overlapping PSSCH, PSCCH, and/or PSFCH transmissions) during the gap.

Additionally and/or alternatively, a TX UE could consider whether a destination is in the gap at a timing when selecting a destination for a PSSCH/PSCCH transmission at the timing (in a Logical Channel Prioritization (LCP) procedure). The TX UE may not select the destination for the PSSCH/PSCCH transmission if the destination is in the gap at the timing.

The gap could be a (standalone) SL CSI-RS gap. The gap could be configured (per-UE) for SL-FR2.

For all above concepts, methods, aspects, and alternatives above and herein, exemplary embodiments are described below.

Note that any of above and herein methods, alternatives, aspects, examples, and embodiments may be combined, in whole or in part, or applied simultaneously or separately.

Preferably in certain embodiments, standalone SL CSI-RS could be replaced by SL CSI-RS (for beam management or for L1-RSRP measurement).

Preferably in certain embodiments, throughout the disclosure, when one beam covers/comprises another beam in spatial domain, it may correspond that an antenna/beamforming gain using/via the another beam is within X dB distortion than the antenna/beamforming gain is using/via the one beam. Preferably in certain embodiments, when the antenna/beamforming gain using/via the another beam is with a distortion larger than X dB than the antenna/beamforming gain is using/via the one beam, the other/another beam is not covered/comprised by the one beam. Preferably in certain embodiments, X could be 3.

Preferably in certain embodiments, throughout the disclosure, SL CSI-RS in frequency domain may be located sparsely. For example, for one SL CSI-RS transmission occasion, SL CSI-RS in 1-st symbol of the one SL CSI-RS transmission occasion may be every Y resource element (e.g., 0, Y-1, 2Y-1, . . . ). Preferably in certain embodiments, Y could be 1, 2, 3, 4, 6, 8, or 12. Alternatively, SL CSI-RS in frequency domain may occupy the same frequency resource(s) (e.g., resource elements in sub-channel(s) indicated by PSCCH).

Preferably in certain embodiments, one SL CSI-RS transmission occasion may comprise one symbol used for Automatic Gain Control (AGC).

Preferably in certain embodiments, 1-st symbol of one SL CSI-RS transmission occasion is used for AGC.

Preferably in certain embodiments, a maximum number of SL CSI-RS transmission occasion(s) in one TTI may be determined based on a higher layer configuration (e.g., sidelink resource pool, carrier, SL BWP.) and/or the UE's capability (e.g., the number of TX/RX beams, whether the UE needs beam change time).

Preferably in certain embodiments, the standalone SL CSI-RS transmission(s) may be triggered/requested when the first UE receives a signaling (e.g., from the second UE/destination) indicating the trigger/request of the standalone SL CSI-RS transmission(s). The signaling may be an SCI, SL MAC CE, or SL RRC configuration.

Preferably in certain embodiments, the standalone SL CSI-RS transmission(s) may be triggered/requested when the first UE detects beam failure or a number of beam failure instance indications (e.g., within a time interval). Preferably in certain embodiments, the standalone SL CSI-RS transmission(s) may be triggered/requested when the first UE detects beam failure or a number of beam failure instance indications (e.g., within a time interval) associated with beam pair link(s) between the first UE and the second UE/destination.

Preferably in certain embodiments, the standalone SL CSI-RS transmission(s) may be triggered/requested when the first UE detects a number of SL HARQ Negative Acknowledgement (NACK)/Discontinuous Transmission (DTX) (e.g., within a time interval) associated with or from the second UE/destination.

Preferably in certain embodiments, the standalone SL CSI-RS transmission(s) may be triggered/requested when the first UE detects channel quality, associated with beam pair link(s) between the first UE and the second UE/destination, being/becoming lower/worse, e.g., RSRP or Received Signal Strength Indicator (RSSI) or RSRP or Signal to Interference and Noise Ratio (SINR) is lower than a threshold. The first UE may measure the RSRP or the RSSI or the RSRP or the SINR via a received/detected channel or reference signal (e.g., PSCCH, PSSCH, PSFCH, SL CSI-RS, SL CSI-RS for beam management, SL CSI-RS for channel measurement) from the second UE/destination.

Preferably in certain embodiments, the standalone SL CSI-RS transmission(s) may be triggered/requested based on a timer, e.g., when or in response to the timer expiring.

Preferably in certain embodiments, the standalone SL CSI-RS transmission(s) may be triggered/requested, when or in response to the first UE enables/configures/activates a procedure/functionality related to beam pairing, beam sweeping, or beam maintenance.

Preferably in certain embodiments, the standalone SL CSI-RS transmission(s) may be triggered/requested based on the first UE implementation.

Preferably in certain embodiments, when the standalone SL CSI-RS transmission(s) is triggered/requested, and when the first UE has no available sidelink resources for the triggered/requested standalone SL CSI-RS transmission(s)), the first UE (e.g., in mode 2 or in UE (autonomous) selection mode) may trigger, in the first trigger timing, the first procedure to determine/derive the first set of identified/valid candidate resources. Preferably in certain embodiments, when the standalone SL CSI-RS transmission(s) is triggered/requested, and when the first UE has no available sidelink resources for the triggered/requested standalone SL CSI-RS transmission(s)), the first UE (e.g., in mode 2 or in UE (autonomous) selection mode) may trigger, in the first trigger timing, to perform the first sensing-based resource selection.

Preferably in certain embodiments, the one or more standalone SL CSI-RS transmission(s)/reception(s)/measurement(s) may be scheduled, assigned, allocated, or reserved by a first sidelink control information in the same sidelink TTI. Preferably in certain embodiments, the first sidelink control information may comprise 1^{st} stage SCI of the first sidelink control information and 2^{nd} stage SCI of the first sidelink control information. The 1^{st} stage SCI of the first sidelink control information is transmitted via PSCCH.

Preferably in certain embodiments, the first UE may transmit the first sidelink control information and perform the one or more SL CSI-RS transmission(s) in the same sidelink TTI. Preferably in certain embodiments, the first UE may transmit the first sidelink control information via a first TX beam. When the first sidelink control information indicates/sets repetition ON or the same TX beam, the first UE would utilize the first TX beam to perform the one or more standalone SL CSI-RS transmission(s). Preferably in certain embodiments and/or alternatively, the first UE may transmit the first sidelink control information via a first TX beam. When the first sidelink control information indicates/sets repetition OFF or different TX beams, the first UE would utilize the one or more first TX beams (e.g., perform TX beam sweeping) to perform the one or more standalone SL CSI-RS transmission(s). The one or more first TX beams may comprise the first TX beam.

Preferably in certain embodiments, the first UE may receive the first sidelink control information and perform the one or more SL CSI-RS reception(s)/measurement(s) in the same sidelink TTI. Preferably in certain embodiments, the first UE may receive the first sidelink control information via a first RX beam. When the first sidelink control information (or a configuration or signaling) indicates/sets repetition ON or the same TX beam, the first UE would utilize the one or more first RX beams (e.g., perform RX beam sweeping) to perform the one or more standalone SL CSI-RS reception(s)/measurement(s). The one or more first RX beams may comprise the first RX beam. Preferably and/or alternatively, the first UE may receive the first sidelink control information via a first RX beam. When the first sidelink control information (or a configuration or signaling) indicates/sets repetition OFF or different TX beams, the first UE would utilize the first RX beam to perform the one or more standalone SL CSI-RS reception(s)/measurement(s).

Preferably in certain embodiments, the one or more standalone SL CSI-RSs are transmitted/multiplexed in non-overlapped symbol(s) (in time domain) in the sidelink TTI. Preferably in certain embodiments, the one or more standalone SL CSI-RSs are not transmitted/multiplexed in frequency domain in the sidelink TTI. Preferably in certain embodiments, in the sidelink TTI, the one or more standalone SL CSI-RSs are transmitted/multiplexed in non-overlapped symbol(s) (in time domain) from transmission of the first sidelink control information. Preferably in certain embodiments, in the sidelink TTI, the one or more standalone SL CSI-RSs are transmitted/multiplexed in non-overlapped symbol(s) (in time domain) from transmission of (1^{st} stage SCI of) the first sidelink control information. Preferably in certain embodiments, in the sidelink TTI, the one or more standalone SL CSI-RSs are transmitted/multiplexed in non-overlapped symbol(s) (in time domain) from transmission of PSCCH.

Preferably in certain embodiments, the standalone SL CSI-RS may be replaced/substituted/changed to multiple SL CSI-RSs in the same sidelink TTI.

Preferably in certain embodiments, the SL CSI-RS may be replaced/substituted/changed to a sidelink reference signal for beam pairing, beam management, beam maintenance or beam sweeping.

Preferably in certain embodiments, the SL CSI-RS may be utilized in FR2 band/spectrum. Preferably in certain embodiments, the SL CSI-RS may be utilized in FR3 or FR4 band/spectrum. Preferably in certain embodiments, the SL CSI-RS may be utilized in carrier frequency higher than 6000 MHz or 10000 MHz.

Preferably in certain embodiments, the any of above concepts, methods, alternatives and embodiments for SL CSI-RS may be applied for other sidelink reference signals (e.g., sidelink reference signal designed/introduced in future 5G, 6G, etc.).

Preferably in certain embodiments, the sidelink TTI may mean a sidelink slot. Preferably in certain embodiments, the sidelink TTI may mean a slot for sidelink. Preferably in certain embodiments, a TTI may be a subframe (for sidelink) or a slot (for sidelink) or a sub-slot (for sidelink). Preferably in certain embodiments, a TTI comprises multiple symbols, e.g., 12 or 14 symbols. Preferably in certain embodiments, a TTI may be a slot (fully/partially) comprising sidelink symbols. Preferably in certain embodiments, a TTI may mean a transmission time interval for a sidelink (data) transmission. Preferably in certain embodiments, a sidelink slot or a slot for sidelink may contain all Orthogonal Frequency Division Multiple access (OFDM) symbols available for sidelink transmission. Preferably in certain embodiments, a sidelink slot or a slot for sidelink may contain a consecutive number of symbols available for sidelink transmission. Preferably in certain embodiments, a sidelink slot or a slot for sidelink means that a slot is included/comprised in a sidelink resource pool.

Preferably in certain embodiments, the symbol may mean a symbol indicated/configured for sidelink.

Preferably in certain embodiments, the slot may mean/comprise a sidelink slot associated with the (sidelink) resource pool. Preferably in certain embodiments, the slot may not mean/comprise a sidelink slot associated with another/other (sidelink) resource pool.

Preferably in certain embodiments, a sub-channel is a unit for sidelink resource allocation/scheduling (for PSSCH). Preferably in certain embodiments, a sub-channel may comprise multiple contagious PRBs in frequency domain. Preferably in certain embodiments, the number of PRBs for each sub-channel may be (pre-)configured for a sidelink resource pool. Preferably in certain embodiments, a sidelink resource pool (pre-)configuration may indicate/configure the number of PRBs for each sub-channel. Preferably in certain embodiments, the number of PRBs for each sub-channel may be any of 10, 12, 15, 20, 25, 50, 75, 100. Preferably in certain embodiments, a sub-channel may be represented as a unit for sidelink resource allocation/scheduling. Preferably in certain embodiments, a sub-channel may mean a set of consecutive PRBs in frequency domain. Preferably in certain embodiments, a sub-channel may mean a set of consecutive resource elements in frequency domain.

Preferably in certain embodiments, the first UE may have/maintain/establish multiple sidelink links/connections on PC5 interface. For different sidelink links/connections, the first UE may perform sidelink transmission/reception to/from different paired UE(s).

Preferably in certain embodiments, the first UE may have/maintain/establish a first sidelink link/connection and a second sidelink link/connection. The paired UE of the first sidelink link/connection may be different from the paired UE of the second sidelink link/connection. Preferably in certain embodiments, the sidelink logical channel(s) associated with (the paired UE of) the first sidelink link/connection are separate/independent from the sidelink logical channel(s) associated with (the paired UE of) the second sidelink link/connection.

Preferably in certain embodiments, the UE may be/mean/comprise/replace a device.

Preferably in certain embodiments, the sidelink transmission/reception may be UE-to-UE transmission/reception. Preferably in certain embodiments, the sidelink transmission/reception may be device-to-device transmission/reception. Preferably in certain embodiments, the sidelink transmission/reception may be Vehicle-to-Everything (V2X) transmission/reception. Preferably in certain embodiments, the sidelink transmission/reception may be Pedestrian-to-Anything (P2X) transmission/reception. Preferably in certain embodiments, the sidelink transmission/reception may be on PC5 interface.

Preferably in certain embodiments, the PC5 interface may be wireless interface for communication between device and device. Preferably in certain embodiments, the PC5 interface may be a wireless interface for communication between devices. Preferably in certain embodiments, the PC5 interface may be a wireless interface for communication between UEs. Preferably in certain embodiments, the PC5 interface may be a wireless interface for V2X or P2X communication. Preferably in certain embodiments, the Uu interface may be a wireless interface for communication between a network node and a device. Preferably in certain embodiments, the Uu interface may be a wireless interface for communication between a network node and a UE.

Preferably in certain embodiments, the first UE may be a first device. Preferably in certain embodiments, the first UE may be a vehicle UE. Preferably in certain embodiments, the first UE may be a V2X UE.

Preferably in certain embodiments, the second UE may be a second device. Preferably in certain embodiments, the second UE may be a vehicle UE. Preferably in certain embodiments, the second device may be a V2X UE.

Preferably in certain embodiments, the first UE and the second device are different devices.

Exemplary embodiments of the present invention are described below.

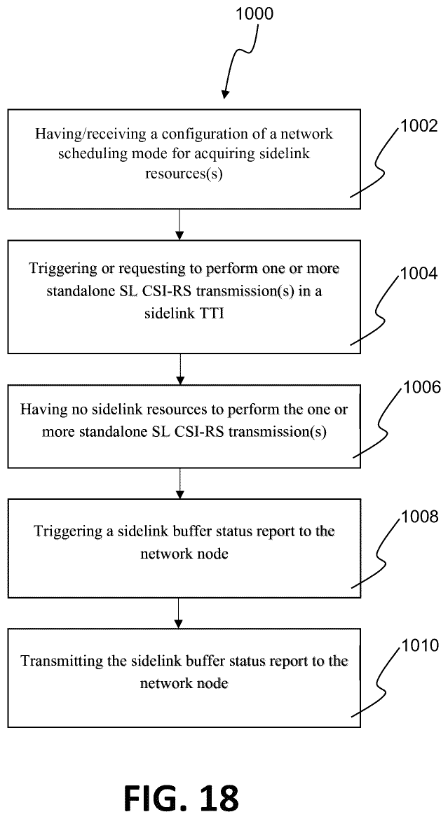

Referring to FIG. 18, with this and other concepts, systems, and methods of the present invention, a method 1000 of a first device comprises having/receiving a configuration of a network scheduling mode for acquiring sidelink resources(s) (step 1002), triggering or requesting to perform one or more standalone SL CSI-RS transmission(s) in a sidelink TTI (step 1004), having no sidelink resources to perform the one or more standalone SL CSI-RS transmission(s) (step 1006), triggering a sidelink buffer status report to the network node (step 1008), and transmitting the sidelink buffer status report to the network node (step 1010).

In various embodiments, the method further comprises receiving sidelink grant from network node after transmitting the sidelink buffer status report, and utilizing sidelink resource(s) based on the sidelink grant to perform the one or more standalone SL CSI-RS transmission(s).

Referring back to FIGS. 3 and 4, in one or more embodiments from the perspective of first device, the device 300 includes a program code 312 stored in memory 310 of the transmitter. The CPU 308 could execute program code 312 to: (i) have/receive a configuration of a network scheduling mode for acquiring sidelink resources(s); (ii) trigger or request to perform one or more standalone SL CSI-RS transmission(s) in a sidelink TTI; (iii) have no sidelink resources to perform the one or more standalone SL CSI-RS transmission(s); (iv) trigger a sidelink buffer status report to the network node; and (v) transmit the sidelink buffer status report to the network node. Moreover, the CPU 308 can execute the program code 312 to perform all of the described actions, steps, and methods described above, below, or otherwise herein.

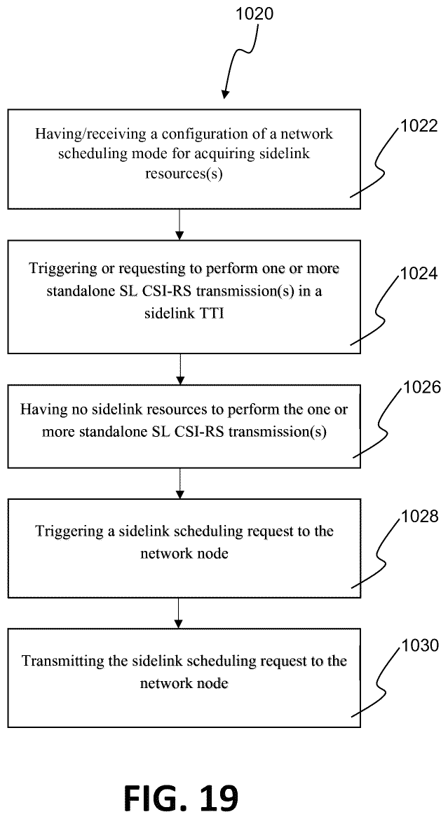

Referring to FIG. 19, with this and other concepts, systems, and methods of the present invention, a method 1020 of a first device comprises having/receiving a configuration of a network scheduling mode for acquiring sidelink resources(s) (step 1022), triggering or requesting to perform one or more standalone SL CSI-RS transmission(s) in a sidelink TTI (step 1024), having no sidelink resources to perform the one or more standalone SL CSI-RS transmission(s) (step 1026), triggering a sidelink scheduling request to the network node (step 1028), and transmitting the sidelink scheduling request to the network node (step 1030).

In various embodiments, the method further comprises receiving a sidelink grant from the network node after transmitting the sidelink scheduling request, and utilizing sidelink resource(s) based on the sidelink grant to perform the one or more standalone SL CSI-RS transmission(s).

Referring back to FIGS. 3 and 4, in one or more embodiments from the perspective of first device, the device 300 includes a program code 312 stored in memory 310 of the transmitter. The CPU 308 could execute program code 312 to: (i) have/receive a configuration of a network scheduling mode for acquiring sidelink resources(s); (ii) trigger or request to perform one or more standalone SL CSI-RS transmission(s) in a sidelink TTI; (iii) have no sidelink resources to perform the one or more standalone SL CSI-RS transmission(s); (iv) trigger a sidelink scheduling request to the network node; and (v) transmit the sidelink scheduling request to the network node. Moreover, the CPU 308 can execute the program code 312 to perform all of the described actions, steps, and methods described above, below, or otherwise herein.

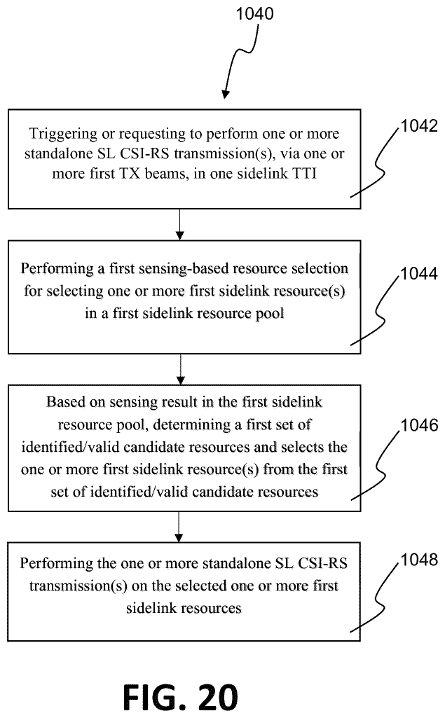

Referring to FIG. 20, with this and other concepts, systems, and methods of the present invention, a method 1040 of a first device comprises triggering or requesting to perform one or more standalone SL CSI-RS transmission(s), via one or more first TX beams, in one sidelink TTI (step 1042), performing a first sensing-based resource selection for selecting one or more first sidelink resource(s) in a first sidelink resource pool (step 1044), based on sensing result in the first sidelink resource pool, determining a first set of identified/valid candidate resources and selects the one or more first sidelink resource(s) from the first set of identified/valid candidate resources (step 1046), and performing the one or more standalone SL CSI-RS transmission(s) on the selected one or more first sidelink resources (step 1048).

In various embodiments, the one or more first TX beams means one first TX beam, and/or the first UE transmits a first sidelink control information, via the one first TX beam in the same one sidelink TTI, for scheduling/allocating/reserving the one or more SL CSI-RS transmission(s), and/or the first device determines the first set of identified/valid candidate resources based on sensing result via one (or more) first RX beam, wherein the one (or more) first RX beam is determined/derived from the one first TX beam.

In various embodiments, the one or more first TX beams means multiple first TX beams, and/or the first UE transmits a first sidelink control information, via one first TX beam in the same one sidelink TTI, for scheduling/allocating/reserving the one or more SL CSI-RS transmission(s), and/or the first device determines the first set of identified/valid candidate resources based on sensing result via one (or more) first RX beam, wherein the one (or more) first RX beam is determined/derived from the one first TX beam.

In various embodiments, the one or more first TX beams means multiple first TX beams, and/or the first UE transmits a first sidelink control information, via one first TX beam in the same one sidelink TTI, for scheduling/allocating/reserving the one or more SL CSI-RS transmission(s), and/or the first device determines the first set of identified/valid candidate resources based on sensing result via multiple first RX beams, wherein the multiple first RX beams are determined/derived from the multiple first TX beams.

Referring back to FIGS. 3 and 4, in one or more embodiments from the perspective of first device, the device 300 includes a program code 312 stored in memory 310 of the transmitter. The CPU 308 could execute program code 312 to: (i) trigger or request to perform one or more standalone SL CSI-RS transmission(s), via one or more first TX beams, in one sidelink TTI; (ii) perform a first sensing-based resource selection for selecting one or more first sidelink resource(s) in a first sidelink resource pool; (iii) based on sensing result in the first sidelink resource pool, determine a first set of identified/valid candidate resources and selects the one or more first sidelink resource(s) from the first set of identified/valid candidate resources; (iv) and perform the one or more standalone SL CSI-RS transmission(s) on the selected one or more first sidelink resources. Moreover, the CPU 308 can execute the program code 312 to perform all of the described actions, steps, and methods described above, below, or otherwise herein.

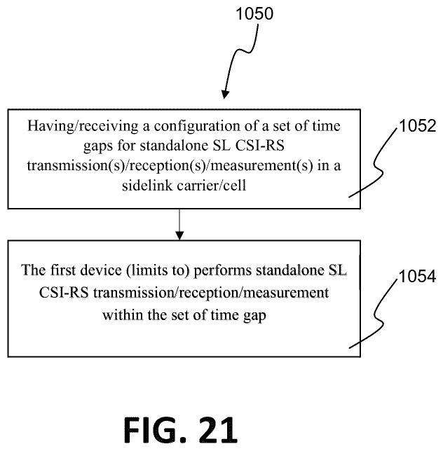

Referring to FIG. 21, with this and other concepts, systems, and methods of the present invention, a method 1050 of a first device comprises having/receiving a configuration of a set of time gaps for standalone SL CSI-RS transmission(s)/reception(s)/measurement(s) in a sidelink carrier/cell (step 1052), and the first device (limits to) performs standalone SL CSI-RS transmission/reception/measurement within the set of time gap (step 1054).

In various embodiments, the first device excludes/prevents from performing sidelink data/feedback transmission(s)/reception(s) within the set of time gaps.

Referring back to FIGS. 3 and 4, in one or more embodiments from the perspective of a first device, the device 300 includes a program code 312 stored in memory 310 of the transmitter. The CPU 308 could execute program code 312 to: (i) have/receive a configuration of a set of time gaps for standalone SL CSI-RS transmission(s)/reception(s)/measurement(s) in a sidelink carrier/cell; and (ii) the first device (limits to) performs standalone SL CSI-RS transmission/reception/measurement within the set of time gap. Moreover, the CPU 308 can execute the program code 312 to perform all of the described actions, steps, and methods described above, below, or otherwise herein.

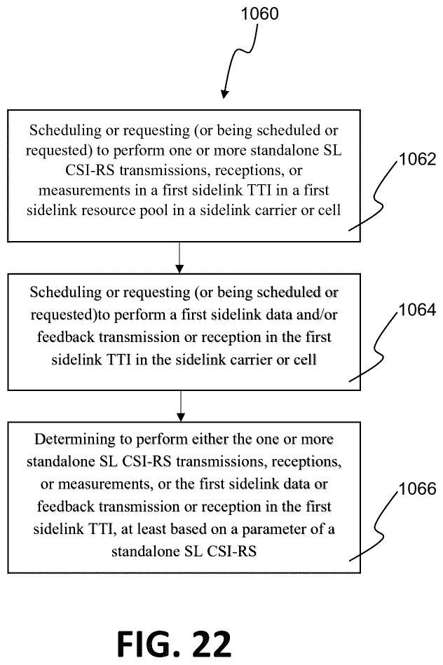

Referring to FIG. 22, with this and other concepts, systems, and methods of the present invention, a method 1060 of a first device comprises scheduling or requesting (or being scheduled or requested) to perform one or more standalone SL CSI-RS transmissions, receptions, or measurements in a first sidelink TTI in a first sidelink resource pool in a sidelink carrier or cell (step 1062), scheduling or requesting (or being scheduled or requested) to perform a first sidelink data and/or feedback transmission or reception in the first sidelink TTI in the sidelink carrier or cell (step 1064), and determining to perform either the one or more standalone SL CSI-RS transmissions, receptions, or measurements, or the first sidelink data or feedback transmission or reception in the first sidelink TTI, at least based on a parameter of a standalone SL CSI-RS (step 1066).

In various embodiments, the parameter of the standalone SL CSI-RS comprises any of: a first priority threshold provided by a configuration of the first sidelink resource pool or a sidelink configuration of the first device, or a priority value provided by the configuration of the first sidelink resource pool, or a priority value provided by a configuration associated with a second device or destination, wherein the one or more standalone SL CSI-RS transmissions are performed for the second device or destination or the one or more standalone SL CSI-RSs are transmitted from the second device or destination, or a priority value associated with a specific SL logical channel associated with a second device or destination, wherein the one or more standalone SL CSI-RS transmissions are performed for the second device or destination or the one or more standalone SL CSI-RSs are transmitted from the second device or destination, or a priority value indicated by a first sidelink control information, wherein the one or more standalone SL CSI-RS receptions or measurements are scheduled, assigned, allocated, or reserved by the first sidelink control information, or the standalone SL CSI-RS transmissions or receptions are considered with higher priority than the sidelink data and/or feedback transmission or reception.

In various embodiments, the first sidelink data and/or feedback transmission or reception is associated with a second priority value. When the second priority value is smaller than the parameter, the first device performs the first sidelink data and/or feedback transmission or reception in the first sidelink TTI, and/or the first device does not perform the one or more standalone SL CSI-RS transmissions or receptions or measurements in the first sidelink TTI. When the second priority value is larger than the parameter, the first device performs the one or more standalone SL CSI-RS transmissions, receptions, or measurements in the first sidelink TTI, and/or the first device does not perform the first sidelink data and/or feedback transmission or reception in the first sidelink TTI.

In various embodiments, the one or more standalone SL CSI-RSs are not associated with specific services or specific higher layer protocol, and/or the one or more standalone SL CSI-RS transmissions, receptions, or measurements are not multiplexed with any sidelink data transmission in the first sidelink TTI, and/or the one or more standalone SL CSI-RS transmissions, receptions, or measurements do not accompany sidelink data transmission in the first sidelink TTI.

In various embodiments, the first device is scheduled or requested to perform one or more non-standalone SL CSI-RS transmissions or receptions in a second sidelink TTI in the sidelink carrier or cell, wherein the one or more non-standalone SL CSI-RS transmissions or receptions are multiplexed with a second sidelink data transmission in the second sidelink TTI, and/or the non-standalone SL CSI-RS transmissions or receptions are not associated with the parameter of the standalone SL CSI-RS, and/or the non-standalone SL CSI-RS transmissions or receptions are not associated with a priority value, and/or there is no priority value for the non-standalone SL CSI-RS transmissions or receptions, and/or the non-standalone SL CSI-RS transmissions or receptions are not associated with a priority threshold, and/or there is no priority threshold for the non-standalone SL CSI-RS transmissions or receptions.

In various embodiments, the first device has or receives a configuration of a network scheduling mode for acquiring sidelink resources. When the first device triggers or requests (or is triggered or requested) to perform the one or more standalone SL CSI-RS transmissions, and/or when the first device has no sidelink resources to perform the one or more standalone SL CSI-RS transmissions, the first device triggers a sidelink buffer status report or a scheduling request to a network node, and/or the first device transmits the sidelink buffer status report or the scheduling request to the network node.

In various embodiments, the first device triggers or requests (or is triggered or requested) to perform the one or more standalone SL CSI-RS transmissions, via one or more first TX beams, and/or one of the one or more standalone SL CSI-RS transmissions is transmitted via one of the one or more first TX beams (respectively), and/or the first device performs a first sensing-based resource selection for selecting at least a first sidelink resource in the first sidelink resource pool, and/or the first device determines a first set of identified or valid candidate resources based on a sensing result in the first sidelink resource pool, and/or the first device selects the first sidelink resource from the first set of identified or valid candidate resources, and/or the first device performs the one or more standalone SL CSI-RS transmissions on the selected first sidelink resource.

In various embodiments, the first device transmits a first sidelink control information via a first TX beam, wherein the first sidelink control information schedules, allocates, or indicates the one or more standalone SL CSI-RS transmissions, and/or the one or more first TX beams comprise the first TX beam, and/or the first device transmits the first sidelink control information and the one or more standalone SL CSI-RS transmissions in the first sidelink TTI.

In various embodiments, the first device determines the first set of identified or valid candidate resources based on a sensing result via a first RX beam, wherein the first RX beam is determined, derived from, or associated with the first TX beam, and/or the first device determines the first set of identified or valid candidate resources based on the sensing result via one or more first RX beams, wherein the one or more first RX beams are determined, derived from, or associated with the first TX beam, and/or the first device determines the first set of identified or valid candidate resources based on the sensing result via one or more first RX beams, wherein the one or more first RX beams are determined, derived from, or associated with the one or more first TX beams.

Referring back to FIGS. 3 and 4, in one or more embodiments from the perspective of a first device, the device 300 includes a program code 312 stored in memory 310 of the transmitter. The CPU 308 could execute program code 312 to: (i) schedule or request (or is scheduled or requested) to perform one or more standalone SL CSI-RS transmissions, receptions, or measurements in a first sidelink TTI in a first sidelink resource pool in a sidelink carrier or cell; (ii) schedule or request (or is scheduled or requested) to perform a first sidelink data and/or feedback transmission or reception in the first sidelink TTI in the sidelink carrier or cell; and (iii) determine to perform either the one or more standalone SL CSI-RS transmissions, receptions, or measurements, or the first sidelink data and/or feedback transmission or reception in the first sidelink TTI, at least based on a parameter of a standalone SL CSI-RS. Moreover, the CPU 308 can execute the program code 312 to perform all of the described actions, steps, and methods described above, below, or otherwise herein.

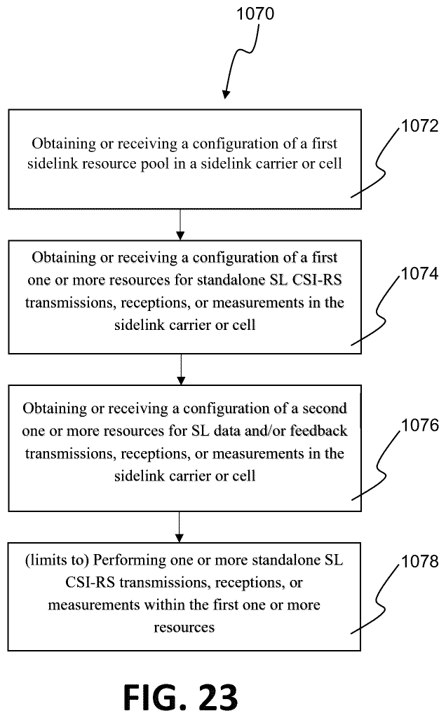

Referring to FIG. 23, with this and other concepts, systems, and methods of the present invention, a method 1070 of a first device comprises obtaining or receiving a configuration of a first sidelink resource pool in a sidelink carrier or cell (step 1072), obtaining or receiving a configuration of a first one or more resources for standalone SL CSI-RS transmissions, receptions, or measurements in the sidelink carrier or cell (step 1074), obtaining or receiving a configuration of a second one or more resources for SL data and/or feedback transmissions, receptions, or measurements in the sidelink carrier or cell (step 1076), and (limits to) performing one or more standalone SL CSI-RS transmissions, receptions, or measurements within the first one or more resources (step 1078).

In various embodiments, the first one or more resources are in the first sidelink resource pool, which is dedicated for standalone SL CSI-RS transmissions, receptions, or measurements, and/or the second one or more resources are in a second sidelink resource pool.

In various embodiments, the first one or more resources and the second one or more resources are in the first sidelink resource pool, and/or the first one or more resources and the second one or more resources are non-overlapped, and/or the first one or more resources are in a first set of TTIs configured for standalone SL CSI-RS transmissions, receptions, or measurements in the first sidelink resource pool, and/or the second one or more resources are in a second set of TTIs configured for SL data and/or feedback transmissions, receptions, or measurements in the first sidelink resource pool, and/or the first set of TTIs and the second set of TTIs are non-overlapped.

In various embodiments, the first one or more resources are in a first set of TTIs configured for standalone SL CSI-RS transmissions, receptions, or measurements in the sidelink carrier or cell, and/or the second one or more resources are in a second set of TTIs configured for SL data and/or feedback transmissions, receptions, or measurements in the sidelink carrier or cell, and/or the first set of TTIs and the second set of TTIs are non-overlapped.

In various embodiments, the method further comprises: excluding or preventing from performing sidelink data or feedback transmissions or receptions within the first one or more resources, and/or excluding or preventing from performing standalone SL CSI-RS transmissions or receptions within the second one or more resources.

In various embodiments, the first device has or receives a configuration of a network scheduling mode for acquiring sidelink resources. When the first device triggers or requests (is triggered or requested) to perform the one or more standalone SL CSI-RS transmissions, and/or when the first device has no sidelink resources to perform the one or more standalone SL CSI-RS transmissions, the first device triggers a sidelink buffer status report or a scheduling request to a network node, and/or the first device transmits the sidelink buffer status report or the scheduling request to the network node.

In various embodiments, the first device triggers or requests (is triggered or requested) to perform one or more standalone SL CSI-RS transmissions, via one or more first TX beams, and/or one of the one or more standalone SL CSI-RS transmissions is transmitted via one of the one or more first TX beams (respectively), and/or the first device performs a first sensing-based resource selection for selecting at least a first sidelink resource in the first sidelink resource pool, and/or the first device determines a first set of identified or valid candidate resources based on a sensing result in the first sidelink resource pool, and/or the first device selects the first sidelink resource from the first set of identified or valid candidate resources, and/or the first device performs the one or more standalone SL CSI-RS transmissions on the selected first sidelink resource.

In various embodiments, the first device transmits a first sidelink control information via a first TX beam, wherein the first sidelink control information schedules, allocates, or indicates the one or more standalone SL CSI-RS transmissions, and/or the one or more first TX beams comprise the first TX beam, and/or the first device transmits the first sidelink control information and the one or more standalone SL CSI-RS transmissions in the first sidelink TTI.

In various embodiments, the first device determines the first set of identified or valid candidate resources based on a sensing result via a first RX beam, wherein the first RX beam is determined, derived from, or associated with the first TX beam, and/or the first device determines the first set of identified or valid candidate resources based on the sensing result via one or more first RX beams, wherein the one or more first RX beams are determined, derived from, or associated with the first TX beam, and/or the first device determines the first set of identified or valid candidate resources based on the sensing result via one or more first RX beams, wherein the one or more first RX beams are determined, derived from, or associated with the one or more first TX beams.

Referring back to FIGS. 3 and 4, in one or more embodiments from the perspective of a first device, the device 300 includes a program code 312 stored in memory 310 of the transmitter. The CPU 308 could execute program code 312 to: (i) obtain or receive a configuration of a first sidelink resource pool in a sidelink carrier or cell; (ii) obtain or receive a configuration of a first one or more resources for standalone SL CSI-RS transmissions, receptions, or measurements in the sidelink carrier or cell; (iii) obtain or receive a configuration of a second one or more resources for SL data and/or feedback transmissions, receptions, or measurements in the sidelink carrier or cell; and (iv) (limits to) perform one or more standalone SL CSI-RS transmissions, receptions, or measurements within the first one or more resources. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a first device, comprising:
being scheduled or requested to perform one or more standalone Sidelink (SL) Channel State Information Reference Signal (CSI-RS) transmissions, receptions, or measurements in a first sidelink Transmission Time Interval (TTI) in a first sidelink resource pool in a sidelink carrier or cell;
being scheduled or requested to perform a first sidelink data and/or feedback transmission or reception in the first sidelink TTI in the sidelink carrier or cell; and
determining to perform either the one or more standalone SL CSI-RS transmissions, receptions, or measurements, or the first sidelink data and/or feedback transmission or reception in the first sidelink TTI, at least based on a parameter of a standalone SL CSI-RS.

2. The method of claim 1, wherein the parameter of the standalone SL CSI-RS comprises any of:
a first priority threshold provided by a configuration of the first sidelink resource pool or a sidelink configuration of the first device, or
a priority value provided by the configuration of the first sidelink resource pool, or
a priority value provided by a configuration associated with a second device or destination, wherein the one or more standalone SL CSI-RS transmissions are performed for the second device or destination or the one or more standalone SL CSI-RSs are transmitted from the second device or destination, or
a priority value associated with a specific SL logical channel associated with a second device or destination, wherein the one or more standalone SL CSI-RS transmissions are performed for the second device or destination or the one or more standalone SL CSI-RSs are transmitted from the second device or destination, or
a priority value indicated by a first sidelink control information, wherein the one or more standalone SL CSI-RS receptions or measurements are scheduled, assigned, allocated, or reserved by the first sidelink control information, or
the standalone SL CSI-RS transmissions or receptions are considered with higher priority than the sidelink data and/or feedback transmission or reception.

3. The method of claim 1, wherein:
the first sidelink data and/or feedback transmission or reception is associated with a second priority value, and/or
when the second priority value is smaller than the parameter, the first device performs the first sidelink data and/or feedback transmission or reception in the first sidelink TTI and/or does not perform the one or more standalone SL CSI-RS transmissions or receptions or measurements in the first sidelink TTI, and/or
when the second priority value is larger than the parameter, the first device performs the one or more standalone SL CSI-RS transmissions, receptions, or measurements in the first sidelink TTI and/or does not perform the first sidelink data and/or feedback transmission or reception in the first sidelink TTI.

4. The method of claim 1, wherein:
the one or more standalone SL CSI-RSs are not associated with specific services or specific higher layer protocol, and/or
the one or more standalone SL CSI-RS transmissions, receptions, or measurements are not multiplexed with any sidelink data transmission in the first sidelink TTI, and/or
the one or more standalone SL CSI-RS transmissions, receptions, or measurements do not accompany sidelink data transmission in the first sidelink TTI.

5. The method of claim 1, wherein:
the first device is scheduled or requested to perform one or more non-standalone SL CSI-RS transmissions or receptions in a second sidelink TTI in the sidelink carrier or cell, wherein the one or more non-standalone SL CSI-RS transmissions or receptions are multiplexed with a second sidelink data transmission in the second sidelink TTI, and/or
the non-standalone SL CSI-RS transmissions or receptions are not associated with the parameter of the standalone SL CSI-RS, and/or
the non-standalone SL CSI-RS transmissions or receptions are not associated with a priority value, and/or
there is no priority value for the non-standalone SL CSI-RS transmissions or receptions, and/or
the non-standalone SL CSI-RS transmissions or receptions are not associated with a priority threshold, and/or
there is no priority threshold for the non-standalone SL CSI-RS transmissions or receptions.

6. The method of claim 1, wherein:
the first device has or receives a configuration of a network scheduling mode for acquiring sidelink resources, and/or
when the first device is triggered or requested to perform the one or more standalone SL CSI-RS transmissions, and when the first device has no sidelink resources to perform the one or more standalone SL CSI-RS transmissions, the first device triggers a sidelink buffer status report or a scheduling request to a network node, and/or the first device transmits the sidelink buffer status report or the scheduling request to the network node.

7. The method of claim 1, wherein:
the first device is triggered or requested to perform the one or more standalone SL CSI-RS transmissions, via one or more first Transmission (TX) beams, and/or
one of the one or more standalone SL CSI-RS transmissions is transmitted via one of the one or more first TX beams, and/or
the first device performs a first sensing-based resource selection for selecting at least a first sidelink resource in the first sidelink resource pool, and/or
the first device determines a first set of identified or valid candidate resources based on a sensing result in the first sidelink resource pool, and/or
the first device selects the first sidelink resource from the first set of identified or valid candidate resources, and/or
the first device performs the one or more standalone SL CSI-RS transmissions on the selected first sidelink resource.

8. The method of claim 7, wherein:
the first device transmits a first sidelink control information via a first TX beam, wherein the first sidelink control information schedules, allocates, or indicates the one or more standalone SL CSI-RS transmissions, and/or
the one or more first TX beams comprise the first TX beam, and/or
the first device transmits the first sidelink control information and the one or more standalone SL CSI-RS transmissions in the first sidelink TTI.

9. The method of claim 8, wherein:
the first device determines the first set of identified or valid candidate resources based on a sensing result via a first Reception (RX) beam, wherein the first RX beam is determined, derived from, or associated with the first TX beam, and/or
the first device determines the first set of identified or valid candidate resources based on the sensing result via one or more first RX beams, wherein the one or more first RX beams are determined, derived from, or associated with the first TX beam, and/or
the first device determines the first set of identified or valid candidate resources based on the sensing result via one or more first RX beams, wherein the one or more first RX beams are determined, derived from, or associated with the one or more first TX beams.

10. A method of a first device, comprising:
obtaining or receiving a configuration of a first sidelink resource pool in a sidelink carrier or cell;
obtaining or receiving a configuration of a first one or more resources for standalone Sidelink (SL) Channel State Information Reference Signal (CSI-RS) transmissions, receptions, or measurements in the sidelink carrier or cell;
obtaining or receiving a configuration of a second one or more resources for SL data and/or feedback transmissions, receptions, or measurements in the sidelink carrier or cell; and
performing one or more standalone SL CSI-RS transmissions, receptions, or measurements within the first one or more resources.

11. The method of claim 10, wherein:
the first one or more resources are in the first sidelink resource pool, which is dedicated for standalone SL CSI-RS transmissions, receptions, or measurements, and/or
the second one or more resources are in a second sidelink resource pool.

12. The method of claim 10, wherein:
the first one or more resources and the second one or more resources are in the first sidelink resource pool, and/or
the first one or more resources and the second one or more resources are non-overlapped, and/or
the first one or more resources are in a first set of Transmission Time Intervals (TTIs) configured for standalone SL CSI-RS transmissions, receptions, or measurements in the first sidelink resource pool, and/or
the second one or more resources are in a second set of TTIs configured for SL data and/or feedback transmissions, receptions, or measurements in the first sidelink resource pool, and/or
the first set of TTIs and the second set of TTIs are non-overlapped.

13. The method of claim 10, wherein:
the first one or more resources are in a first set of TTIs configured for standalone SL CSI-RS transmissions, receptions, or measurements in the sidelink carrier or cell, and/or
the second one or more resources are in a second set of TTIs configured for SL data and/or feedback transmissions, receptions, or measurements in the sidelink carrier or cell, and/or
the first set of TTIs and the second set of TTIs are non-overlapped.

14. The method of claim 10, further comprising:
excluding or preventing from performing sidelink data or feedback transmissions or receptions within the first one or more resources; and/or
excluding or preventing from performing standalone SL CSI-RS transmissions or receptions within the second one or more resources.

15. The method of claim 10, wherein:
the first device has or receives a configuration of a network scheduling mode for acquiring sidelink resources, and/or
when the first device is triggered or requested to perform the one or more standalone SL CSI-RS transmissions, and when the first device has no sidelink resources to perform the one or more standalone SL CSI-RS transmissions, the first device triggers a sidelink buffer status report or a scheduling request to a network node, and/or the first device transmits the sidelink buffer status report or the scheduling request to the network node.

16. The method of claim 10, wherein:
the first device is triggered or requested to perform the one or more standalone SL CSI-RS transmissions, via one or more first Transmission (TX) beams, and/or
one of the one or more standalone SL CSI-RS transmissions is transmitted via one of the one or more first TX beams, and/or
the first device performs a first sensing-based resource selection for selecting at least a first sidelink resource in the first sidelink resource pool, and/or
the first device determines a first set of identified or valid candidate resources based on a sensing result in the first sidelink resource pool, and/or
the first device selects the first sidelink resource from the first set of identified or valid candidate resources, and/or
the first device performs the one or more standalone SL CSI-RS transmissions on the selected first sidelink resource.

17. The method of claim 16, wherein:
the first device transmits a first sidelink control information via a first TX beam, wherein the first sidelink control information schedules, allocates, or indicates the one or more standalone SL CSI-RS transmissions, and/or
the one or more first TX beams comprise the first TX beam, and/or
the first device transmits the first sidelink control information and the one or more standalone SL CSI-RS transmissions in the first sidelink TTI.

18. The method of claim 17, wherein:
the first device determines the first set of identified or valid candidate resources based on a sensing result via a first Reception (RX) beam, wherein the first RX beam is determined, derived from, or associated with the first TX beam, and/or
the first device determines the first set of identified or valid candidate resources based on the sensing result via one or more first RX beams, wherein the one or more first RX beams are determined, derived from, or associated with the first TX beam, and/or
the first device determines the first set of identified or valid candidate resources based on the sensing result via one or more first RX beams, wherein the one or more first RX beams are determined, derived from, or associated with the one or more first TX beams.

19. A first device, comprising:
a memory; and
a processor operatively coupled with the memory, wherein the processor is configured to execute a program code to:
be scheduled or requested to perform one or more standalone Sidelink (SL) Channel State Information Reference Signal (CSI-RS) transmissions, receptions, or measurements in a first sidelink Transmission Time Interval (TTI) in a first sidelink resource pool in a sidelink carrier or cell;
be scheduled or requested to perform a first sidelink data and/or feedback transmission or reception in the first sidelink TTI in the sidelink carrier or cell; and
determine to perform either the one or more standalone SL CSI-RS transmissions, receptions, or measurements, or the first sidelink data and/or feedback transmission or reception in the first sidelink TTI, at least based on a parameter of a standalone SL CSI-RS.

20. The first device of claim 19, wherein the parameter of the standalone SL CSI-RS comprises any of:
a first priority threshold provided by a configuration of the first sidelink resource pool or a sidelink configuration of the first device, or
a priority value provided by the configuration of the first sidelink resource pool, or
a priority value provided by a configuration associated with a second device or destination, wherein the one or more standalone SL CSI-RS transmissions are performed for the second device or destination or the one or more standalone SL CSI-RSs are transmitted from the second device or destination, or
a priority value associated with a specific SL logical channel associated with a second device or destination, wherein the one or more standalone SL CSI-RS transmissions are performed for the second device or destination or the one or more standalone SL CSI-RSs are transmitted from the second device or destination, or
a priority value indicated by a first sidelink control information, wherein the one or more standalone SL CSI-RS receptions or measurements are scheduled, assigned, allocated, or reserved by the first sidelink control information, or
the standalone SL CSI-RS transmissions or receptions are considered with higher priority than the sidelink data and/or feedback transmission or reception.
